(19) United States
(12) Patent Application Publication
(10) Pub. No.: US 2008/0102262 A1
(43) Pub. Date: May 1, 2008

(54) Radiation Curable Composition and Curing Product Thereof, and Laminate Including the Same

(75) Inventors: Akira Esaki, Kanagawa (JP); Osamu Matsuda, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI CHEMICAL CORPORATION, Tokyo (JP)

(21) Appl. No.: 11/718,835

(22) PCT Filed: Nov. 8, 2005
(86) PCT No.: PCT/JP05/20425

§ 371 Date: Jul. 23, 2007

(30) Foreign Application Priority Data
Nov. 8, 2004 (JP) 2004-323949
Oct. 11, 2005 (JP) 2005-295993

(51) Int. Cl. B32B 27/00; C08F 2/46

(52) U.S. Cl. 428/220

(57) ABSTRACT

A radiation-curable composition capable of giving a cured product which has excellent transparency, mechanical strength and an excellent balance between surface hardness and resistance to deformation by heat/humidity; the cured product; and a multilayer structure which has a layer of the cured product and is suitable for use as an optical recording medium, etc, are provided A radiation-curable composition which comprises a monomer having a radiation-curable group and gives a cured product having the following properties: (1) when the cured product has a thickness of 100±5 μm, the cured product has a light transmittance at a wavelength of 550 nm of 80% or higher; (2) a multilayer structure where a layer of the cured product having a thickness of 100±5 μm is formed on a poly(ethylene terephthalate) film having a thickness of 100±5 μm, has a surface hardness of HB or higher; and (3) when a multilayer structure where the cured product having a thickness of 100±5 μm is formed on a disk made of a polycarbonate having a diameter of 130 mm and a thickness of 1.2±0.2 mm, is placed in an environment of 80° C. and 85% RH for 100 hours, then an absolute value |a| of an amount of warpage, a (mm), on the circumference of the multilayer structure is 0.5 mm or less.

### TECHNICAL FIELD

The present invention relates to a radiation-curable composition, a cured product obtained therefrom, and a multilayer structure including the cured product. More particularly, the invention relates to a radiation-curable composition capable of giving a cured product which has excellent transparency and mechanical strength and an excellent balance between surface hardness and resistance to deformation by heat/humidity, and to the cured product and a multilayer structure which has a layer of the cured product and is suitable for use as an optical recording medium, etc.

### BACKGROUND ART

Radiation-curable compositions are extensively used as various coating materials and adhesive materials or in optical applications. Examples of the optical applications of radiation-curable compositions include a protective film for the information recording layer in information recording media, especially optical recording media. In particular, investigations are recently being made on next-generation high-density optical disks for which a blue laser light is used (see patent document 1). Although a urethane (meth)acrylate is used for the protective layer in patent document 1, this protective layer itself has insufficient hardness because this protective layer is formed more thickly than those heretofore in use. In this prior-art technique, a hard coat layer made of a cured product formed from fine colloidal silica particles and an ethylenically unsaturated compound is superposed on that protective layer to thereby balance strength and cure shrinkage. However, such a protective film of the multilayer type has been still insufficient for practical use with respect to cost, operating efficiency, etc.

On the other hand, the present applicant found that when a radiation-curable composition which contains silica particles comprising an alkoxysilane oligomer hydrolyzate and further contains a monomer having a urethane bond, e.g., a urethane (meth)acrylate, and/or an oligomer thereof and other ingredients is used in an optical application to form a cured product layer having a thickness as large as tens of micrometers or more on a substrate, then the cured product layer in the resultant multilayer structure can not only have surface hardness and transparency but have excellent adhesion to the substrate. The inventor previously made a patent application based on this finding (see patent document 2). However, as a result of intensive investigations on that curable composition, the inventor found that when the composition is used to form a cured product layer having a thickness of tens of micrometers or larger on a substrate, the resultant multilayer structure has the following drawbacks. This multilayer structure is apt to warp in a high-temperature high-humidity environment, and the warpage generated is sometimes enhanced when the multilayer structure which has undergone that environment is placed at ordinary temperature and ordinary humidity. There is a fear that these warped states may inhibit recorded data from being read by a drive or that when the multilayer structure further has a hard coat layer formed on the surface of the cured product layer, the warped states may be causative of cracking of the hard coat layer. It was thus found that there is room for an improvement in resistance to deformation by heat/humidity.

It is also known that a radiation-curable composition which contains no inorganic material such as silica particles and contains a urethane di(meth)acrylate as a product of a reaction between an alicyclic diisocyanate and a hydroxyl-containing alkyl(meth)acrylate, another urethane di(meth)acrylate, and an ethylenically unsaturated compound is excellent in transparency, wearing resistance, recording-film-protecting properties, and mechanical properties and also in the resistance to deformation by heat/humidity when used in the same application (see patent document 3). However, investigations made by the present inventor revealed that this composition is insufficient in surface hardness. On the other hand, a radiation-curable composition which contains a urethane acrylate obtained using a diol having an amide group and further contains an alicyclic (meth)acrylate and an ethylenically unsaturated compound is known to be excellent in adhesion to substrates, unsusceptibility to cure shrinkage, mechanical strength, and non-corrosive properties and also in the resistance to deformation by heat/humidity (see patent document 4). However, investigations made by the present inventor revealed that this composition has a high viscosity because the diol in the urethane acrylate has an amide group.

Incidentally, a radiation-curable composition which is suitable for use in modifying the surface properties of printed plastic film coatings and contains no inorganic material such as silica particles is known. This composition employs a combination of a urethane acrylate having a polyether polyol skeleton and a urethane acrylate having a polycarbonate polyol skeleton. Due to this combination, the composition has excellent curability and satisfactory adhesion to various plastic substrates and can form a film excellent in nonfouling properties, flexibility, wearing resistance, marring resistance, etc. (see patent document 5). However, investigations made by the present inventor revealed that this composition shows considerable cure shrinkage and hence has a problem that when this composition is used to form a cured product layer having a thickness as large as 50 μm or more on a rigid substrate, then the cured product layer suffers cracking or peeling from the substrate or causes substrate deformation, etc.

[Patent Document 1] JP-A-2002-245672

[Patent Document 2] JP-A-2004-169028

[Patent Document 3] JP-A-2003-263780

[Patent Document 4] JP-A-2003-231725

[Patent Document 5] JP-A-8-92342

### DISCLOSURE OF THE INVENTION

### Problems that the Invention is to Solve

The invention has been achieved in view of the fact that the known radiation-curable compositions for use in, e.g., forming a protective film for an information recording layer, which are required to have transparency, give a cured product which in a thick film form has insufficient resistance to deformation by heat/humidity as described above. Accordingly, an object of the invention is to provide a radiation-curable composition capable of giving a cured product which has excellent transparency and mechanical strength and an excellent balance between surface hardness and resistance to deformation by heat/humidity. Another object of the invention is to provide the cured product. Still another object of the invention is to provide a multilayer structure which has a layer of the cured product and is suitable for use as an optical recording medium, etc.

### Means for Solving the Problems

The inventor made intensive investigations in order to overcome the problems described above. As a result, the inventor has found that a radiation-curable composition comprising silica particles and a monomer having a urethane bond and/or an oligomer thereof can give the desired cured product when the monomer having a urethane bond and/or the oligomer thereof is one containing two or more kinds of skeletons selected from a polyether polyol skeleton, a polyester polyol skeleton, and a polycarbonate polyol skeleton. Those objects were found to be thus accomplished, and the invention has been completed.

The invention provides a radiation-curable composition which comprises a monomer having a radiation-curable group and/or an oligomer thereof, wherein a cured product obtained by irradiating with ultraviolet in a light intensity of 1 J/cm², has the following properties (1) to (3):

(1) when the cured product has a thickness of 100±5 μm, the cured product has a light transmittance at a wavelength of 550 nm of 80% or higher;
(2) a multilayer structure where a layer of the cured product having a thickness of 100±5 μm is formed on a poly(ethylene terephthalate) film having a thickness of 100±5 μm, has a surface hardness of HB or higher; and
(3) when a multilayer structure where the cured product having a thickness of 100±5 μm is formed on a disk made of a polycarbonate having a diameter of 130 mm and a thickness of 1.2±0.2 mm, is placed in an environment of 80° C. and 85% RH for 100 hours, then an absolute value |a| of an amount of warpage, a (mm), on the circumference of the multilayer structure is 0.5 mm or less.

The invention further provides a radiation-curable composition which comprises a monomer having a radiation-curable group and/or an oligomer thereof, wherein the radiation-curable composition has a viscosity at 25° C. of 1,000-5,000 cP, and a cured product obtained by irradiating with ultraviolet in a light intensity of 1 J/cm², has the following properties (1) to (3):

(1) when the cured product has a thickness of 100±5 μm, the cured product has a light transmittance at a wavelength of 550 nm, of 80% or higher;
(2) a multilayer structure where the cured product having a thickness of 100±5 μm is formed on a poly(ethylene terephthalate) film having a thickness of 100±5 μm, has a surface hardness of HB or higher; and
(3) when a multilayer structure where the cured product having a thickness of 100±5 μm is formed on a disk made of a polycarbonate having a diameter of 130 mm and a thickness of 1.2±0.2 mm, is placed in an environment of 80° C. and 85% RH for 100 hours and subsequently placed in an environment of 23° C. and 65% RH for 168 hours, then an absolute value |b| of the amount of warpage, b (mm), is 0.5 mm or less.

The invention furthermore provides a radiation-curable composition which comprises a monomer having a urethane bond and/or an oligomer thereof each obtained by reacting at least a compound having two or more isocyanate groups in the molecule, a high-molecular polyol, a (meth)acrylate having a hydroxyl group, and a low-molecular polyol in which all the hydroxyl groups are connected by a hydrocarbon group, wherein the radiation-curable composition has a viscosity at 25° C. of 1,000-5,000 centipoise (cP), and a cured product obtained by irradiating with ultraviolet in a light intensity of 1 J/cm², has the following properties (1) to (3):

(1) when the cured product has a thickness of 100±5 μm, the cured product has a light transmittance at a wavelength of 550 nm, of 80% or higher;
(2) a multilayer structure where the cured product having a thickness of 100±5 μm is formed on a poly(ethylene terephthalate) film having a thickness of 100±5 μm, has a surface hardness of 2 B or higher; and
(3) when a multilayer structure where the cured product having a thickness of 100±5 μm is formed on a disk made of a polycarbonate having a diameter of 130 mm and a thickness of 1.2±0.2 mm, is placed in an environment of 80° C. and 85% RH for 100 hours and subsequently placed in an environment of 23° C. and 65% RH for 168 hours, then an absolute value |b| of an amount of warpage, b (mm), is 0.5 mm or less.

### ADVANTAGES OF THE INVENTION

According to the invention, a radiation-curable composition can be provided which is capable of giving a cured product having excellent transparency and mechanical strength and an excellent balance between surface hardness and resistance to deformation by heat/humidity. The invention can further provide the cured product and a multilayer structure which has a layer of the cured product and is suitable for use as an optical recording medium, etc.

### BRIEF DESCRIPTION OF THE DRAWING

FIG. 1 is a sectional view illustrating one embodiment of the multilayer structure of the invention for use as an optical recording medium.

### DESCRIPTION OF REFERENCE NUMERALS

1: substrate
3: protective layer
5: recording/reproducing functional layer
51: reflecting layer
52, 54: dielectric layer
53: recording layer
10: optical recording medium

### BEST MODE FOR CARRYING OUT THE INVENTION

Typical embodiments of the invention will be explained below in detail.

[Components of Radiation-Curable Composition]

### (1) Monomer Having Radiation-Curable Group and/or Oligomer Thereof

Examples of the monomer having a urethane bond in the radiation-curable composition of the invention include compounds obtained by a method in which a chloroformic ester is reacted with ammonia or an amine, a method in which a compound having one or more isocyanate groups is reacted with a compound having a hydroxyl group, or a method in which urea is reacted with a compound having a hydroxyl group. Examples thereof further include compounds formed by the oligomerization of those compounds having reactive groups. It is generally convenient to use a urethane oligomer among those compounds. The urethane oligomer is generally produced by reacting a compound having two or more isocyanate groups in the molecule with a compound having a hydroxyl group in an ordinary manner.

Examples of the compound having two or more isocyanate groups in the molecule include polyisocyanates such as tetramethylene diisocyanate, hexamethylene diisocyanate, trimethylhexamethylene diisocyanate, bis(isocyanatomethyl)cyclohexane, cyclohexane diisocyanate, bis(isocyanatocyclohexyl)methane, isophorone diisocyanate, tolylene diisocyanate, xylylene diisocyanate, diphenylmethane diisocyanate, m-phenylene diisocyanate, and naphthalene diisocyanate. From the standpoint of obtaining a urethane oligomer having a satisfactory hue, it is preferred to use one of or a combination of two or more of bis(isocyanatomethyl)cyclohexane, cyclohexane diisocyanate, bis(isocyanatocyclohexyl)methane, and isophorone diisocyanate among those polyisocyanates.

The compound having a hydroxyl group to be used preferably is a polyol having two or more hydroxyl groups. Examples thereof include low-molecular polyols such as alkanepolyols, e.g., ethylene glycol, 1,2-propanediol, 1,3-propanediol, 2-methyl-1,3-propanediol, 1,3-butanediol, 1,4-butanediol, 1,5-pentanediol, 2-methyl-1,5-pentanediol, neopentyl glycol, 3-methyl-1,5-pentanediol, 2,3,5-trimethyl-1,5-pentanediol, 1,6-hexanediol, 2-ethyl-1,6-hexanediol, 2,2,4-trimethyl-1,6-hexanediol, 1,8-octanediol, trimethylolpropane, pentaerythritol, sorbitol, mannitol, glycerol, 1,2-dimethylolcyclohexane, 1,3-dimethylolcyclohexane, and 1,4-dimethylolcyclohexane, and high-molecular polyols which are polymers of these low-molecular polyols. The term low-molecular polyol herein means a polyol having a molecular weight of 200 or lower, preferably 170 or lower, more preferably 150 or lower, while the term high-molecular polyol herein means a polyol having a molecular weight higher than 200, preferably 400 or higher, more preferably 600 or higher.

In particular, preferred low-molecular polyols for use for the invention are ones in which all the hydroxyl groups are connected by a hydrocarbon group as those shown above as examples. Preferred high-molecular polyols are polyether polyols having one or more ether bonds, polyester polyols having one or more ester bonds and obtained by reaction with a polybasic acid or by the ring-opening polymerization of a cyclic ester, or polycarbonate polyols having one or more carbonate bonds and obtained by reaction with a carbonate. Examples of high-molecular polyols usable for the invention further include polyamide polyols having one or more amide bonds. It is preferred to use one or more polyols in which at least part, preferably at least 15% by mole, more preferably at least 30% by mole, of all polyols has a molecular weight of 500-2,500.

Besides the polyol polymers shown above, examples of the polyether polyols include polymers formed by the ring-opening polymerization of tetrahydrofuran and other cyclic ethers, such as polytetramethylene glycol, and adducts of the polyols with an alkylene oxide such as ethylene oxide, propylene oxide, 1,2-butylene oxide, 1,3-butylene oxide, 2,3-butylene oxide, tetrahydrofuran, styrene oxide, or epichlorohydrin.

Examples of the polyester polyols include products of the reaction of the polyols with a polybasic acid such as maleic acid, fumaric acid, adipic acid, sebacic acid, or phthalic acid and polymers formed by the ring-opening polymerization of caprolactone and other cyclic esters, such as polycaprolactone.

Examples of the polycarbonate polyols include products of the reaction of the polyols with an alkylene carbonate such as ethylene carbonate, 1,2-propylene carbonate, or 1,2-butylene carbonate, a diaryl carbonate such as diphenyl carbonate, 4-methyldiphenyl carbonate, 4-ethyldiphenyl carbonate, 4-propyldiphenyl carbonate, 4,4′-dimethyldiphenyl carbonate, 2-tolyl 4-tolyl carbonate, 4,4′-diethyldiphenyl carbonate, 4,4′-dipropyldiphenyl carbonate, phenyl toluoyl carbonate, bischlorophenyl carbonate, phenyl chlorophenyl carbonate, phenyl naphthyl carbonate, or dinaphthyl carbonate, or a dialkyl carbonate such as dimethyl carbonate, diethyl carbonate, di-n-propyl carbonate, diisopropyl carbonate, di-n-butyl carbonate, diisobutyl carbonate, di-t-butyl carbonate, di-n-amyl carbonate, or diisoamyl carbonate.

Examples of the polyamide polyols include reaction products obtained from a cyclic hydroxycarboxylic acid ester such as γ-butyrolactone, γ-valerolactone, or ∈-caprolactone, ammonia or a primary amine such as ethanolamine or a secondary amine such as diethanolamine, N-methylethanolamine, N-ethylethanolamine, or N-phenylethanolamine, and a compound having a hydroxyl group, such as 2-amino-1-butanol, by putting these reactants together in, e.g., stoichiometric amounts, evenly mixing the reactants by stirring, and heating the mixture at a temperature of 70° C. or higher for 6-48 hours.

When part of the compound having a hydroxyl group is replaced by a compound having both a hydroxyl group and a (meth)acryloyl group, then a urethane acrylate oligomer can be produced. The amount of the compound having a (meth)acryloyl group to be used is generally 30-70% based on all compounds having a hydroxyl group. By changing the proportion thereof, the molecular weight of the oligomer to be obtained can be regulated.

Examples of the compound having both a hydroxyl group and a (meth)acryloyl group include hydroxyethyl(meth)acrylate, hydroxypropyl(meth)acrylate, hydroxybutyl(meth)acrylate, adducts of a glycidyl ether compound with (meth)acrylic acid, and mono(meth)acrylates of glycol compounds.

Furthermore, a urethane oligomer having a (meth)acryloyl group at each end can be produced by the addition reaction of one molecule of a compound having two or more isocyanate groups in the molecule with two molecules of a compound having both a hydroxyl group and a (meth)acryloyl group.

In particular, the urethane oligomer having a (meth)acryloyl group at each end has an advantage that it further enhances the adhesion and surface hardness of the cured resin to be obtained.

The addition reaction between the compound having isocyanate groups and the compound having a hydroxyl group can be conducted by a known method. For example, a mixture of the hydroxyl-containing compound and an addition reaction catalyst, e.g., dibutyltin laurate, is dropped at 50-90° C. in the presence of the compound containing isocyanate groups to thereby conduct the reaction.

Those monomers and/or oligomers thereof each having a urethane bond for use in the invention may be characterized by containing two or more kinds of skeletons selected from the group consisting of the polyether polyol skeleton, polyester polyol skeleton, and polycarbonate polyol skeleton described above. This constitution enables the radiation-curable composition of the invention to give a cured product having an excellent balance between surface hardness and resistance to deformation by heat/humidity.

With respect to combinations of the two or more kinds of skeletons selected from the group consisting of the polyether polyol skeleton, polyester polyol skeleton, and polycarbonate polyol skeleton described above, the monomer and/or oligomer may contain the three kinds simultaneously. It is, however, preferred that two kinds be contained. Examples thereof include (1) the case where a polyether polyol skeleton and a polyester polyol skeleton are contained, (2) the case where a polyether polyol skeleton and a polycarbonate polyol skeleton are contained, and (3) the case where a polyester polyol skeleton and a polycarbonate polyol skeleton are contained. The case (1) brings about better resistance to deformation by heat/humidity, while the case (3) brings about higher surface hardness. The case (2) brings about properties intermediate between (1) and (3). It should, however, be noted that in the cases (2) and (3), in which a polycarbonate polyol skeleton is contained, the silica particles which will be described later show reduced dispersibility and there is a possibility that the silica particles, depending on the degree of a surface treatment thereof, might cause gelation in the composition or opacify the composition. It is therefore preferred, for example, that the amount of a trialkoxysilane having an alkyl group to be used as the silane coupling agent which will be described later should be reduced. Especially preferably, no trialkoxysilane having an alkyl group is used. Consequently, of the cases (1) to (3), the case (1) is most preferred because it is free from such limitations.

Examples of the case where the monomer and/or oligomer thereof each having a urethane bond in the invention contains two or more kinds of skeletons selected from the group consisting of the polyether polyol skeleton, polyester polyol skeleton, and polycarbonate polyol skeleton described above include the case in which the monomer and/or oligomer is a mixture of two or more of monomers respectively having those skeletons and/or oligomers thereof and the case in which the monomer and/or oligomer is a monomer having two or more of those skeletons in the same molecule and/or an oligomer thereof. Preferred of these is the case where the monomer and/or oligomer is a monomer having two or more of those skeletons in the same molecule and/or an oligomer thereof, from the standpoints of the storage stability of the composition, transparency of the composition and cured product, etc.

In the monomer and/or oligomer thereof each having a urethane bond in the invention, the proportion of constituent units derived from the polyether polyol skeleton, polyester polyol skeleton, or polycarbonate polyol skeleton is as follows. The proportion of polyether polyol skeletons, based on all polyol skeletons, is preferably 20% by weight or higher, more preferably 30% by weight or higher, especially preferably 40% by weight or higher, and is preferably 90% by weight or lower, more preferably 85% by weight or lower, especially preferably 80% by weight or lower. In case where the proportion of polyether polyol skeletons is lower than the lower limit in that range, the composition tends to give a cured product having reduced surface hardness or reduced resistance to heat/humidity. On the other hand, in case where the proportion thereof exceeds the upper limit in that range, the composition tends to give a cured product having an increased water absorption or reduced dimensional stability. The proportion of polyester polyol skeletons is preferably 10% by weight or higher, more preferably 15% by weight or higher, especially preferably 20% by weight or higher, and is preferably 80% by weight or lower, more preferably 70% by weight or lower, especially preferably 60% by weight or lower. In case where the proportion of polyester polyol skeletons is lower than the lower limit in that range, the composition tends to give a cured product having reduced resistance to heat/humidity. On the other hand, in case where the proportion thereof exceeds the upper limit in that range, the composition tends to give a cured product having reduced surface hardness or reduced dimensional stability.

The monomer and/or oligomer thereof each having a urethane bond in the invention may have, in part thereof, a skeleton of a so-called acid polyol having an acid group, e.g., a sulfo, phosphate, or carboxyl group, and two or more hydroxyl groups so as to be improved in adhesion to substrates or for other purposes. Examples of the acid polyol include sulfonic acids and alkali metal salts or amine salts thereof, such as 2-sulfo-1,4-butanediol and alkali metal salts thereof, e.g., the sodium salt, 5-sulfo-di-β-hydroxyethylisophthalates and alkali metal salts thereof, e.g., the sodium salt, N,N-bis(2-hydroxyethyl)aminoethylsulfonic acid and the tetramethylammonium salt, tetraethylammonium salt, and benzyltriethylammonium salt of the acid; phosphoric acid esters and amine salts or alkali metal salts thereof, such as bis(2-hydroxyethyl)phosphate and the tetramethylammonium salt and alkali metal salts thereof, e.g., the sodium salt; and compounds having two hydroxyl groups and a carboxyl group per molecule, such as alkanolcarboxylic acids such as dimethylolacetic acid, dimethylolpropionic acid, dimethylolbutanoic acid, dimethylolheptanoic acid, dimethylolnonanoic acid, and dihydroxybenzoic acid and caprolactone adducts of these acids, and half ester compounds of polyoxypropylenetriol with maleic anhydride or phthalic anhydride. The content of the acid polyol in the monomer and/or oligomer thereof each having a urethane bond in the invention is preferably 30% by weight or higher, more preferably 20% by weight or higher, especially preferably 10% by weight or higher.

The monomer and/or oligomer thereof described above which each has one or more urethane bonds preferably is a highly transparent material. For example, the monomer and/or oligomer preferably is a compound having no aromatic ring. A curable composition containing a monomer containing an aromatic ring and/or an oligomer thereof disadvantageously gives a cured product which has been colored or which is colorless first but is colored or increasingly colored during storage. Namely, the cured product yellows. This yellowing is thought to be because the double-bond parts as a component of the aromatic ring undergo an irreversible change in structure by the action of energy rays. Consequently, use of the monomer and/or oligomer thereof each having a structure having no aromatic ring is advantageous in that the cured product undergoes no deterioration in hue and no decrease in light transmission and is suitable for use especially in applications where colorlessness and transparency are required, as in optoelectronics.

Of monomers and/or oligomers thereof each having a urethane bond, a monomer having no aromatic ring and/or oligomer thereof can be produced by subjecting one or more isocyanate-group-containing compounds containing no aromatic ring and one or more hydroxyl-containing compounds containing no aromatic ring, among the isocyanate and hydroxy compounds enumerated above, to addition reaction. For example, it is preferred to use one of or a combination of two or more of bis(isocyanatomethyl)cyclohexane, cyclohexane diisocyanate, bis(isocyanatocyclohexyl)methane, and isophorone diisocyanate as the isocyanate compound(s).

In the radiation-curable composition of the invention, the monomer and/or oligomer thereof each having a urethane bond generally has one or more radiation-curable functional groups. This constitution has an advantage that the monomer or oligomer having a urethane bond is incorporated into and united with a radiation-cured network structure and, hence, the cured product has enhanced cohesiveness, resulting in reduced susceptibility to cohesive failure and improved adhesion. Furthermore, the effect of inhibiting oxygen from moving freely is heightened and this brings about an advantage that surface hardness improves.

The radiation-curable groups are not particularly limited as long as they are polymerizable by the action of a radiation. Examples thereof include groups having radical reactivity, groups having cationic photoreactivity such as a cationically photocurable glycidyl group, groups having anionic photoreactivity, and groups having thiol-ene photoreactivity such as a thiol group. Preferred of these are groups having radical reactivity.

Examples of the functional groups having radical reactivity include (meth)acryloyl and vinyl. Especially preferred of these is (meth)acryloyl from the standpoints of the rate of polymerization reaction, transparency, and applicability. In the case where (meth)acryloyl groups are used, the proportion thereof is not particularly limited as long as at least 50% by number of all radiation-curable functional groups are (meth)acryloyl.

The monomer and/or oligomer thereof preferably is one which mainly comprises one or more compounds having two or more radiation-curable groups per molecule. The term “mainly comprises” herein means that the one or more compounds account for at least 50% by weight of all the monomer and/or oligomer thereof. In this case, the monomer and/or oligomer can form a three-dimensional network structure through radiation-induced polymerization reaction to thereby give an insoluble and infusible cured resin. In the invention, the composition can be cured at a high rate by polymerizing the radiation-curable groups with a radiation such as actinic energy rays (e.g., ultraviolet) or electron beams. Curing with a radiation generally proceeds at an exceedingly high rate on the order of second and can hence give a cured product having a high degree of transparency. In contrast, thermal polymerization is undesirable because it requires much time, i.e., from tens of minutes to several hours.

In the invention, a monomer having a urethane bond may be used alone, or an oligomer having a urethane bond may be used alone. Alternatively, a mixture of both may be used. Since many of such monomers are liquids having a lower viscosity than such oligomers, use of these monomers is advantageous when they are mixed with other ingredients. There also is an advantage that coating or molding such as, e.g., casting is easy. It should, however, be noted that some monomers are toxic and care must be taken. On the other hand, the oligomers generally have a high viscosity and may be difficult to handle. However, use of oligomers tends to enable the composition to attain excellent surface hardness and show reduced cure shrinkage. In addition, many oligomers have an advantage that they give a cured product satisfactory in mechanical properties, in particular, tensile properties and flexural properties.

The monomer and oligomer having a urethane bond in the invention may be hydrophilic, but preferably are hydrophobic. The monomer and/or oligomer thereof each having a urethane bond which is to be used preferably is an oligomer having a relatively high molecular weight. The molecular weight thereof is preferably 1,000 or higher, more preferably 2,000 or higher, and is generally 50,000 or lower, preferably 30,000 or lower, more preferably 20,000 or lower, even more preferably 10,000 or lower, especially preferably 5,000 or lower.

When the oligomer used is one having such a relatively high molecular weight, the composition tends to give a cured product improved in surface hardness and adhesion. Although the reasons for this have not been elucidated, the following is thought. Since the composition containing this oligomer tends to show reduced cure shrinkage, the composition is thought to have a relatively low functional-group density and efficiently undergo a curing reaction and the residual strain caused by cure shrinkage at the adhesion interface is small. These are presumed to be relevant to the improvements in surface hardness and adhesion. Such a high-molecular oligomer may be used alone, or a mixture of two or more such high-molecular oligomers may be used. It is also possible to use the oligomer(s) in combination with other monomers or oligomers having a lower molecular weight. When an oligomer having an exceedingly high molecule weight is used, there are cases where the composition has an increased viscosity and impaired moldability or applicability. This problem can be mitigated by increasing the amount of a low-molecular oligomer or monomer or reactive diluent to be added.

Use of a monomer and/or oligomer thereof each having a urethane bond in the radiation-curable composition of the invention has an advantage that the cured product obtained from the composition has enhanced long-term adhesion and increased surface hardness. The phenomenon in which adhesion improves when a monomer and/or oligomer thereof each having a urethane bond is used is thought to be attributable to enhanced interaction between the cured product and the adherend due to the electrical polarity of the urethane bonds. On the other hand, the reasons why surface hardness improves when a monomer and/or oligomer thereof each having a urethane bond is used have not been elucidated. However, the following is thought. In a composition in which a monomer and/or oligomer thereof each having a urethane bond is contained in an amount not smaller than a given value, intramolecular hydrogen bonds and intermolecular hydrogen bonds are apt to be formed due to the electrical polarity of the urethane bonds. These hydrogen bonds are thought to enhance the cohesiveness of the organic molecules and, as a result, oxygen is inhibited from freely moving in the composition and inhibiting radical polymerization. These are presumed to be main reasons for the improvement.

In general, the content of the monomer and/or oligomer thereof in the radiation-curable composition is preferably 40% by weight or higher, more preferably 50% by weight or higher, and is preferably 95% by weight or lower, more preferably 90% by weight or lower. Too low contents thereof are undesirable because this composition has reduced moldability in forming a cured product and gives a cured product which has reduced mechanical strength and is apt to crack. Conversely, too high contents thereof are undesirable because this composition gives a cured product having reduced surface hardness.

### (2) Compound Having Ethylenically Unsaturated Group

Besides containing the monomer having a radiation-curable group and/or oligomer thereof, the radiation-curable composition of the invention may further contain other radiation-curable monomers and/or oligomers thereof, preferably a bi- or trifunctional (meth)acrylate compound.

Examples of the bi- or trifunctional (meth)acrylate compound include aliphatic chain poly(meth)acrylates, alicyclic poly(meth)acrylates, and aromatic poly(meth)acrylates. Specific examples thereof include (meth)acrylates having a polyether skeleton, such as polyethylene glycol di(meth)acrylate, 1,2-polypropylene glycol di(meth)acrylate, 1,3-polypropylene glycol di(meth)acrylate, polytetramethylene glycol di(meth)acrylate, 1,2-polybutylene glycol di(meth)acrylate, polyisobutylene glycol di(meth)acrylate, the di(meth)acrylate of an adduct of a bisphenol such as bisphenol A, F, or S with an alkylene oxide such as ethylene oxide, propylene oxide, or butylene oxide, the di(meth)acrylate of a hydrogenation derivative of a bisphenol such as bisphenol A, F, or S, and the di(meth)acrylates of block or random copolymers of various polyether polyol compounds and other compounds. Other examples thereof are (meth)acrylates having various functionalities of 2 and higher which include bifunctional (meth)acrylates such as hexanediol di(meth)acrylate, 2,2-bis[4-(meth)acryloyloxyphenyl]propane, 2,2-bis[4-(2-(meth)acryloyloxyethoxy)phenyl]propane, bis(hydroxymethyl)tricyclo[5.2.1.0^{2,6}]decane dimethacrylate, p-bis[β-(meth)acryloyloxyethylthio]xylylene, and 4,4′-bis[β-(meth)acryloyloxyethylthio]diphenyl sulfone, trifunctional (meth)acrylates such as trimethylolpropane tris(meth)acrylate, glycerol tris(meth)acrylate, and pentaerythritol tris(meth)acrylate, tetrafunctional (meth)acrylates such as pentaerythritol tetrakis(meth)acrylate, and (meth)acrylates having a functionality of 5 or higher, such as dipentaerythritol hexa(meth)acrylate. Preferred of these are the bifunctional (meth)acrylates from the standpoint of the controllability of crosslinking reaction. For improving the heat resistance and surface hardness of the cured product having a crosslinked structure or for another purpose, it is preferred to use a (meth)acrylate having a functionality of 3 or higher. Examples thereof include trimethylolpropane tris(meth)acrylate, pentaerythritol tris(meth)acrylate, and dipentaerythritol hexa(meth)acrylate, which were shown above, and further include trifunctional (meth)acrylates having an isocyanurate skeleton.

Examples thereof further include (meth)acrylates which are bi- or trifunctional or have a higher functionality obtained, for example, by: a method comprising mixing a cyclic hydroxycarboxylic acid ester, such as γ-butyrolactone, γ-valerolactone, δ-valerolactone, or ∈-caprolactone, with an amino alcohol compound containing a primary or secondary amino group, such as ethanolamine, diethanolamine, N-methylethanolamine, N-ethylethanolamine, N-phenylethanolamine, 2-amino-1-butanol, 2-amino-2-ethyl-1,3-propanediol, or 6-amino-1-hexanol, in an equivalent ratio, heating the mixture at 90-100° C. for 6 hours or more to synthesize an amide group-containing alcohol, and subjecting this alcohol as a precursor to dehydrating esterification with (meth)acrylic acid in the presence of a catalyst; or a method in which the precursor is subjected to transesterification with a (meth)acrylic ester in the presence of a transesterification catalyst. Specific examples of such polyfunctional (meth)acrylates include N-methyl-N-2-(meth)acryloyloxyethyl-3-(meth)acryloyloxypropanamide, N-methyl-N-2-(meth)acryloyloxyethyl-4-(meth)acryloyloxybutanamide, N-methyl-N-2-(meth)acryloyloxyethyl-5-(meth)acryloyloxypentanamide, N-methyl-N-2-(meth)acryloyloxyethyl-6-(meth)acryloyloxyhexanamide, N-ethyl-N-2-(meth)acryloyloxyethyl-3-(meth)acryloyloxypropanamide, N-ethyl-N-2-(meth)acryloyloxyethyl-4-(meth)acryloyloxybutanamide, N-ethyl-N-2-(meth)acryloyloxyethyl-5-(meth)acryloyloxypentanamide, N-ethyl-N-2-(meth)acryloyloxyethyl-6-(meth)acryloyloxyhexanamide, N-2-(meth)acryloyloxyethyl-3-(meth)acryloyloxypropanamide, N-2-(meth)acryloyloxyethyl-4-(meth)acryloyloxybutanamide, N-2-(meth)acryloyloxyethyl-5-(meth)acryloyloxypentanamide, N-2-(meth)acryloyloxyethyl-6-(meth)acryloyloxyhexanamide, N-methyl-N-2-(meth)acryloyloxypropyl-3-(meth)acryloyloxypropanamide, N-methyl-N-2-(meth)acryloyloxypropyl-4-(meth)acryloyloxybutanamide, N-methyl-N-2-(meth)acryloyloxypropyl-5-(meth)acryloyloxypentanamide, N-methyl-N-2-(meth)acryloyloxypropyl-6-(meth)acryloyloxyhexanamide, N-methyl-N-4-(meth)acryloyloxybutyl-3-(meth)acryloyloxypropanamide, N-methyl-N-4-(meth)acryloyloxybutyl-4-(meth)acryloyloxybutanamide, N-methyl-N-4-(meth)acryloyloxybutyl-5-(meth)acryloyloxypentanamide, N-methyl-N-4-(meth)acryloyloxybutyl-6-(meth)acryloyloxyhexanamide, N,N-bis[2-(meth)acryloyloxyethyl]-4-(meth)acryloyloxybutanamide, N,N-bis[3-(meth)acryloyloxypropyl]-4-(meth)acryloyloxybutanamide, N,N-bis[2-(meth)acryloyloxypropyl]-4-(meth)acryloyloxybutanamide, and N,N-bis[4-(meth)acryloyloxybutyl]-4-(meth)acryloyloxybutanamide.

It is also preferred to add a (meth)acrylate compound containing a hydroxyl group as an ethylenically unsaturated compound for the purpose of improving adhesiveness or adhesion. Examples of this compound include hydroxyethyl(meth)acrylate.

Especially preferred of the (meth)acrylate compounds enumerated above as examples are the ingredient A and ingredient B shown below. To add these ingredients is preferred from the standpoint of realizing a satisfactory balance between the transparency and reduced optical distortion of the polymer to be obtained. Ingredient A is a bis(meth)acrylate which has an alicyclic skeleton and is represented by the following general formula (I).

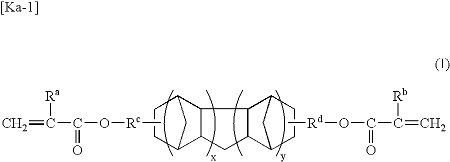

### [In formula (I), R^{a} and R^{b} each independently represent a hydrogen atom or a methyl group; R^{c} and R^{d} each independently represent an alkylene group having up to 6 carbon atoms; x is 1 or 2; and y is 0 or 1.]

Examples of ingredient A, which is represented by general formula (I), include bis(hydroxymethyl)tricyclo[5.2.1.0^{2,6}]decane diacrylate, bis(hydroxymethyl)tricyclo[5.2.1.0^{2,6}]decane dimethacrylate, bis(hydroxymethyl)tricyclo[5.2.1.0^{2,6}]decane acrylate methacrylate, mixtures of these, bis(hydroxymethyl)pentacyclo[6.5.1.1^{3,6}.0^{2,7}.0^{9,13}]pentadecane diacrylate, bis(hydroxymethyl)pentacyclo[6.5.1.1^{3,6}.0^{2,7}.0^{9,13}]pentadecane dimethacrylate, bis(hydroxymethyl)pentacyclo[6.5.1.1^{3,6}.0^{2,7}.0^{9,13}]pentadecane acrylate methacrylate, and mixtures of these. Two or more of these tricyclodecane compounds and pentacyclodecane compounds may be used in combination.

Ingredient B is a bis(meth)acrylate which has a sulfur atom and is represented by the following general formula (II).

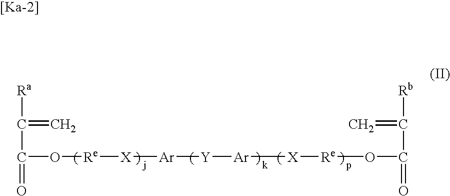

[In formula (II), R^{a} and R^{b} have the same meaning as the R^{a} and R^{b} in general formula (I), and R^{e}'s each represent an alkylene group having 1-6 carbon atoms. Ar's each represent an arylene or aralkylene group having 6-30 carbon atoms, provided that the hydrogen atoms thereof may have been replaced by halogen atoms other than fluorine. X's each represent an oxygen atom or a sulfur atom, provided that when all the X's are oxygen atoms, then at least one of the Y's represents a sulfur atom or a sulfone group (—SO₂—) and that when at least one of the X's is a sulfur atom, then the Y's each represent one of a sulfur atom, a sulfone group, a carbonyl group (—CO—), and an alkylene, aralkylene, alkylene ether, aralkylene ether, alkylene thioether, or aralkylene thioether group having 1-12 carbon atoms. Symbols j and p each independently represent an integer of 1-5, and k represents an integer of 0-10, provided that when k is 0, then X represents a sulfur atom.]

Examples of ingredient B, which is represented by general formula (II), include α,α′-bis[β-(meth)acryloyloxyethylthio]-p-xylene, α,α′-bis[β-(meth)acryloyloxyethylthio]-m-xylene, α,α′-bis[β-(meth)acryloyloxyethylthio]-2,3,5,6-tetrachloro-p-xylene, 4,4′-bis[β-(meth)acryloyloxyethoxy]diphenyl sulfide, 4,4′-bis[β-(meth)acryloyloxyethoxy]diphenyl sulfone, 4,4′-bis[β-(meth)acryloyloxyethylthio]diphenyl sulfide, 4,4′-bis[β-(meth)acryloyloxyethylthio]diphenyl sulfone, 4,4′-bis[β-(meth)acryloyloxyethylthio]diphenyl ketone, 2,4′-bis[β-(meth)acryloyloxyethylthio]diphenyl ketone, 5,5′-tetrabromodiphenyl ketone, β,β′-bis[p-(meth)acryloyloxyphenylthio]diethyl ether, and β,β′-bis[p-(meth)acryloyloxyphenylthio]diethyl thioether. Two or more of these may be used in combination.

Of those examples of ingredient A and ingredient B, bis(hydroxymethyl)tricyclo[5.2.1.0^{2,6}]decane dimethacrylate is especially preferably used because it imparts excellent transparency and heat resistance. The amount of those optionally usable radiation-curable monomers and/or oligomers thereof to be used is preferably up to 50% by weight, more preferably up to 30% by weight, based on the composition excluding all inorganic ingredients.

### (3) Reactive Diluent

A reactive diluent may be added to the radiation-curable composition of the invention for the purpose of, e.g., regulating the viscosity of the composition. In the invention, the reactive diluent is a low-viscosity liquid compound, which generally is a monofunctional low-molecular compound. Examples thereof include compounds having a vinyl or (meth)acryloyl group and mercaptans. Specific examples of such compounds include aromatic vinyl monomers, vinyl ester monomers, vinyl ethers, (meth)acrylamides, (meth)acrylic esters, and di(meth)acrylates. However, compounds of a structure having no aromatic ring are preferred from the standpoints of hue and light transmission. Especially preferred of these are (meth)acrylates having an alicyclic skeleton, such as (meth)acryloylmorpholine, tetrahydrofurfuryl(meth)acrylate, cyclohexyl(meth)acrylate, isobornyl(meth)acrylate, and (meth)acrylates having a tricyclodecane skeleton, (meth)acrylamides such as N,N-dimethylacrylamide, and aliphatic (meth)acrylates such as hexanediol di(meth)acrylate and neopentyl glycol di(meth)acrylate, from the standpoint of imparting a satisfactory hue and an appropriate viscosity.

Furthermore, compounds having both a hydroxyl group and a (meth)acryloyl group, such as hydroxyethyl(meth)acrylate, hydroxypropyl(meth)acrylate, and hydroxybutyl(meth)acrylate, are also usable for this purpose. Use of these compounds is preferred because it may improve the adhesion of the composition to glasses.

The amount of those reactive diluents to be used is preferably 0.1-30% by weight based on the radiation-curable composition. Too small amounts thereof are undesirable because the diluting effect is low. On the other hand, too large amounts thereof are undesirable because this composition not only tends to give a cured product which is brittle and has reduced mechanical strength but also shows enhanced cure shrinkage.

### (4) Polymerization Initiator

It is generally preferred to add a polymerization initiator to the radiation-curable composition of the invention in order to initiate the polymerization reaction which proceeds by the action of actinic energy rays (e.g., ultraviolet). As this polymerization initiator is generally used a radical generator which is a compound having the property of generating a radical by the action of light. Known such compounds can be used. Examples of the radical generator include benzophenone, 2,4,6-trimethylbenzophenone, 4,4-bis(diethylamino)benzophenone, 4-phenylbenzophenone, methyl o-benzoylbenzoate, thioxanthone, diethylthioxanthone, isopropylthioxanthone, chlorothioxanthone, 2-ethylanthraquinone, t-butylanthraquinone, diethoxyacetophenone, 2-hydroxy-2-methyl-1-phenylpropan-1-one, benzyl dimethyl ketal, 1-hydroxycyclohexyl phenyl ketone, benzoin methyl ether, benzoin ethyl ether, benzoin isopropyl ether, benzoin isobutyl ether, methylbenzoyl formate, 2-methyl-1-[4-(methylthio)phenyl]-2-morpholinopropan-1-one, 2,6-dimethylbenzoyldiphenylphosphine oxide, 2,4,6-trimethylbenzoyldiphenylphosphine oxide, bis(2,6-dimethoxybenzoyl)-2,4,4-trimethylpentylphosphine oxide, and bis(2,4,6-trimethylbenzoyl)phenylphosphine oxide. Two or more of these may be used in combination. Preferred of these are 1-hydroxycyclohexyl phenyl ketone, 2,4,6-trimethylbenzoyldiphenylphosphine oxide, and benzophenone.

In the case where the cured product to be obtained from the radiation-curable composition of the invention is for use in, e.g., optical recording media for which a laser having a wavelength of 380-800 nm is used as a light source, it is preferred to select a suitable kind of radical generator from those radical generators and a suitable amount thereof so as to enable the laser light to pass through the cured product layer in an amount sufficient for reading. It is especially preferred in this case to use a radical generator of the short-wavelength light sensitization type which gives a cured product layer less apt to absorb the laser light. Examples of such radical generators of the short-wavelength light sensitization type include benzophenone, 2,4,6-trimethylbenzophenone, 4-phenylbenzophenone, methyl o-benzoylbenzoate, diethoxyacetophenone, 2-hydroxy-2-methyl-1-phenylpropan-1-one, benzyl dimethyl ketal, 1-hydroxycyclohexyl phenyl ketone, benzoin methyl ether, benzoin ethyl ether, benzoin isopropyl ether, benzoin isobutyl ether, and methyl benzoylformate. Especially preferred of these are those having a hydroxyl group, such as 1-hydroxycyclohexyl phenyl ketone.

The amount of such a radical generator to be added is generally 0.001 part by weight or larger, preferably 0.01 part by weight or larger, more preferably 0.05 parts by weight or larger, especially preferably 0.1 part by weight or larger, per 100 parts by weight of the total amount of all monomers containing one or more radiation-curable functional groups and/or oligomers thereof. However, the amount thereof is generally 10 parts by weight or smaller, preferably 9 parts by weight or smaller, more preferably 8 parts by weight or smaller, especially preferably 7 parts by weight or smaller. When the radical generator is added in too large an amount, there are cases where not only the polymerization reaction proceeds abruptly to bring about enhanced optical distortion but also the resultant cured product has an impaired hue. On the other hand, when the radical generator is added in too small an amount, there are cases where the composition cannot be sufficiently cured. In the case where electron beams are used to initiate the polymerization reaction, it is preferred to use no radical generator although the radical generators shown above may be used.

A combination of any of those radical generators and a known sensitizer such as, e.g., methyl 4-dimethylaminobenzoate, ethyl 4-dimethylaminobenzoate, amyl 4-dimethylaminobenzoate, or 4-dimethylaminoacetophenone may be used as a polymerization initiator.

### (5) Surface Tension Regulator

A surface tension regulator may be added to the radiation-curable composition of the invention for the purpose of lowering the surface tension of the composition to improve applicability to substrates. Examples thereof include low-molecular and high-molecular surfactants, silicone compounds and various modifications thereof (e.g., polyether-modified compounds and fluorine-modified compounds), sorbitan esters, and various leveling agents, antifoamers, rheological-property controller, and release agents. Especially preferred of these are silicone compounds such as, e.g., “Polyflow KL510” (manufactured by Kyoeisha Chemical Co., Ltd.), polyether-modified silicone compounds such as, e.g., “KF351A” (manufactured by Shin-Etsu Chemical Co., Ltd.), and fluorine-modified surfactants. This is because these compounds not only can advantageously lower the surface tension but also have the property of being less apt to cause coating defects and are excellent also in antifouling properties, slip properties, and environmental resistance. The amount of the surface tension regulator to be added is generally up to 5% by weight, preferably up to 3% by weight, more preferably in the range of 0.01-1% by weight, based on the composition, although it varies depending on the kind of the regulator.

### (6) Solvent

A solvent may be used in the radiation-curable composition of the invention. The solvent preferably is one which is colorless and transparent. For example, one of or a combination of two or more of alcohols, glycol derivatives, hydrocarbons, esters, ketones, ethers, and the like can be used. Examples of the alcohols include methanol, ethanol, isopropyl alcohol, n-butyl alcohol, isobutyl alcohol, octanol, n-propyl alcohol, and acetylacetone alcohol. Examples of the ketones include acetone, methyl ethyl ketone, and methyl isobutyl ketone. Especially preferred of these is methanol, ethanol, or acetone. However, smaller solvent amounts are preferred, for example, from the standpoint of operating efficiency in curing reaction. The amount of the solvent to be used is preferably up to 95% by weight, more preferably up to 30% by weight, even more preferably up to 20% by weight, especially preferably up to 10% by weight, particularly preferably up to 5% by weight, based on the composition. Most preferably, no solvent is used.

### (7) Other Auxiliary Ingredients

Other auxiliary ingredients such as additives may be added to the radiation-curable composition of the invention according to need as long as the cured product to be produced does not depart considerably from the purposes of the invention. Examples of the auxiliary ingredients include stabilizers such as antioxidants, heat stabilizers, and light absorbers; fillers such as glass fibers, glass beads, mica, talc, kaolin, metal fibers, and metal powders; carbon materials such as carbon fibers, carbon black, graphite, carbon nanotubes, and C₆₀ and other fullerenes (Fillers, fullerenes, and the like are inclusively referred to as inorganic filler ingredients.); modifiers such as antistatic agents, plasticizers, release agents, antifoamers, leveling agents, anti-settling agents, surfactants, and thixotropic agents; colorants such as pigments, dyes, and hue regulators; and monomers and/or oligomers thereof and ingredients such as a hardener, catalyst, and hardening accelerator which are necessary for the synthesis of inorganic ingredients. The amount of such auxiliary ingredients to be added is not particularly limited as long as the cured product to be produced does not depart considerably from the purposes of the invention. However, the amount thereof is generally up to 20% by weight based on the radiation-curable composition.

Of those ingredients, silica as a filler will be explained below in detail. In the radiation-curable composition of the invention, the term silica means any of general silicon oxides; the proportion of silicon to oxygen and whether the silica is crystalline or amorphous are not matter. Besides the commercially available silica particles in the state of being dispersed in a solvent or in a powder form, examples of the silica include silica particles induced and synthesized from raw materials such as, e.g., alkoxysilanes. However, silica particles in the state of being dispersed in a solvent or silica particles induced and synthesized from a raw material such as an alkoxysilane are more preferred from the standpoint of mixability and dispersibility in preparing the radiation-curable composition.

In the invention, the silica particles preferably are ultrafine particles and have a number-average particle diameter of preferably 0.5 nm or larger, more preferably 1 nm or larger. In case where the number-average particle diameter thereof is too small, the ultrafine particles are extremely apt to aggregate and the composition tends to give a cured product considerably reduced in transparency and mechanical strength. In addition, the properties brought about by the quantum effect tend to become insufficient. The number-average particle diameter thereof is preferably 50 nm or smaller, more preferably 40 nm or smaller, even more preferably 30 nm or smaller, especially preferably 15 nm or smaller, most preferably 12 nm or smaller.

The silica particles may be contained in such an amount that the content of preferably silica particles having a particle diameter larger than 30 nm, more preferably silica particles having a particle diameter larger than 15 nm, is preferably up to 1% by weight, more preferably up to 0.5% by weight, based on the radiation-curable composition. Alternatively, the content of such silica particles in the cured product is preferably up to 1% by volume, more preferably up to 0.5% by volume, based on the cured product. Too large contents thereof are undesirable because light scattering is enhanced, resulting in a reduced transmittance.

For determining the number-average particle diameter, found values for images obtained through an examination with a transmission electron microscope (TEM) are used. Namely, when an ultrafine particle is examined, the diameter of a circle having the same area as an image of this ultrafine particle is defined as the diameter of the particle. Particle diameters thus determined are used for calculating the number-average particle diameter, for example, by a known technique for the statistical processing of image data. It is desirable that the number of ultrafine-particle images to be used in this statistical processing (number of data to be statistically processed) be as large as possible. For example, the number of particle images arbitrarily selected for the processing is at least 50 or larger, preferably 80 or larger, more preferably 100 or larger, from the standpoint of reproducibility. The content in terms of % by volume of the particles in the cured product is calculated through conversion to the volume of spheres whose diameters are the same as the particle diameters determined by the method shown above.

As the silica particles in the state of being dispersed in a solvent, use can be made of, for example, a dispersion having a solid content of 10-40% by weight. Examples of the dispersion medium include alcohols such as methyl alcohol, isopropyl alcohol, n-butyl alcohol, and isobutyl alcohol; glycols such as ethylene glycol; esters such as ethyl Cellosolve; amides such as dimethylacetamide; hydrocarbons such as xylene; ketones; ethers; and mixtures of these. Preferred of these are isopropyl alcohol, n-butyl alcohol, isobutyl alcohol, ethyl Cellosolve, and mixtures of two or more thereof. This is because such dispersion media have a satisfactory compatibility with organic ingredients and this is advantageous for obtaining a transparent cured product. The silica particles to be used here can be ones which have undergone a surface treatment with a surface-treating agent such as, e.g., a surfactant or silane coupling agent. Use of a surface-treating agent can prevent the particles from aggregating or enlarging, whereby a transparent radiation-curable composition which contains highly dispersed particles can be obtained.

Examples of the silica particles induced and synthesized from a raw material such as an alkoxysilane include silica particles comprising a hydrolyzate of an alkoxysilane oligomer. The ordinary silica particles which have hitherto been used generally have a broad particle diameter distribution and include particles having a particle diameter larger than, e.g., 50 nm. Use of the ordinary silica particles hence frequently results in poor transparency and further poses a problem that particle sedimentation is apt to occur. Although products from which large particles have been removed (so-called cut products) are known, they are apt to aggregate to form secondary particles and most of these impair transparency. In this respect, the specific synthesis method comprising the hydrolysis of an alkoxysilane oligomer has advantages that silica particles having an exceedingly small particle diameter are stably obtained and that these silica particles have the property of being less apt to aggregate and, hence, high transparency can be obtained therewith.

The term hydrolyzate herein means a product obtained by one or more reactions including at least a hydrolysis reaction. The reactions may involve dehydrating condensation or the like. The hydrolysis reaction includes an alcohol-eliminating reaction. Alkoxysilanes are compounds comprising a silicon atom and one or more alkoxy groups bonded thereto, and yield alkoxysilane oligomers through a hydrolysis reaction and a dehydrating condensation reaction (or alcohol-eliminating condensation). In order for the alkoxysilane oligomer to have compatibility with water and the solvents shown below, it is preferred that the alkyl chains of the alkoxysilane to be used in the invention should not be too long. The alkyl chains each have generally about 1-5 carbon atoms, preferably about 1-3 carbon atoms. Examples of the alkoxysilane include tetramethoxysilane and tetraethoxysilane.

The silica particles to be used in the invention preferably are ones obtained from the alkoxysilane oligomer as a raw material. Use of an alkoxysilane monomer is undesirable for the following and other reasons. When an alkoxysilane monomer is used, particle diameter regulation is difficult and this is apt to result in a broad particle diameter distribution and uneven particle diameters. Because of this tendency, a transparent composition is difficult to obtain. In addition, some monomers are toxic and undesirable from the standpoint of safety/sanitation. The oligomer can be produced by a known method such as, e.g., the method described in JP-A-7-48454.

The hydrolysis of an alkoxysilane oligomer may be conducted by adding a given amount of water to the alkoxysilane oligomer in a specific solvent and causing a catalyst to act thereon. Ultrafine silica particles can be obtained by this hydrolysis reaction. The solvent can be one of or a combination of two or more of alcohols, glycol derivatives, hydrocarbons, esters, ketones, ethers, and the like. Especially preferred of these are alcohols, ethers, and ketones.

Specific examples of the alcohols include methanol, ethanol, isopropyl alcohol, n-butyl alcohol, isobutyl alcohol, octanol, n-propyl alcohol, and acetylacetone alcohol. Specific examples of the ethers include tetrahydrofuran, methoxypropanol, and methoxybutanol. Specific examples of the ketones include acetone, methyl ethyl ketone, and methyl isobutyl ketone. From the standpoint of enabling the silica particles, which are hydrophilic, to be stably present, the alkyl chain of each of these alcohols and ketones preferably is short. Especially preferred are methanol, ethanol, acetone, tetrahydrofuran, methoxypropanol, and methoxybutanol. Of these, methanol and tetrahydrofuran have an advantage that the methanol generating upon alkoxysilane oligomer hydrolysis is easy to remove.

The amount of water necessary for the hydrolysis reaction of the alkoxysilane oligomer is generally at least 0.05 times by mole, more preferably at least 0.3 times by mole, the amount of the alkoxy groups possessed by the alkoxysilane oligomer. Too small water amounts are undesirable because silica particles do not grow to a sufficient size and, hence, desired properties cannot be imparted. In general, the water amount is regulated to up to 1.5 times by mole, preferably up to 1.3 times by mole, the amount of the alkoxy groups possessed by the alkoxysilane oligomer. Excessively large water amounts are undesirable because the alkoxysilane oligomer is apt to form a gel. It is preferred that the alkoxysilane oligomer should be compatible with the solvent to be used and water.

As the catalyst for the hydrolysis, use can be made of one of or a combination of two or more of metal chelate compounds, organic acids, metal alkoxides, boron compounds, and the like. Especially preferred are metal chelate compounds and organic acids. Examples of the metal chelate compounds include aluminum tris(acetylacetonate), titanium tetrakis(acetylacetonate), titanium bis(isopropoxy)bis(acetylacetonate), zirconium tetrakis(acetylacetonate), zirconium bis(butoxy)bis(acetylacetonate), and zirconium bis(isopropoxy)bis(acetylacetonate). Although one of or a combination of two or more of these can be used, aluminum tris(acetylacetonate) is especially preferred.

Examples of the organic acids include formic acid, acetic acid, propionic acid, and maleic acid. Although one of or a combination of two or more of these can be used, maleic acid is especially preferred. Use of maleic acid is preferred because it has an advantage that the cured product obtained by radiation-curing this composition tends to have a satisfactory hue and reduced yellowness.

The amount of these catalyst ingredients to be added is not particularly limited as long as it is in a range where these ingredients can sufficiently perform their function. In general, however, the amount thereof is preferably 0.1 part by weight or larger, more preferably 0.5 parts by weight or larger, per 100 parts by weight of the alkoxysilane oligomer. On the other hand, even when the catalyst is added in too large an amount, the function is not changed. Consequently, the amount thereof is generally preferably 10 parts by weight or smaller, more preferably 5 parts by weight or smaller.

Use of the silica particles comprising a hydrolyzate of an alkoxysilane oligomer has an advantage that ultrafine particles having far higher evenness in particle diameter than the silica particles heretofore in general use as a filler ingredient can be added to the radiation-curable composition. Furthermore, since the silica particles comprising a hydrolyzate of an alkoxysilane oligomer further have the property of being less apt to aggregate, there also is an advantage that the particles can be evenly dispersed in the radiation-curable composition. Consequently, these silica particles, even when added in a large amount, do not impair radiation transmission and, hence, the silica particles can be added in an amount sufficient to enhance dimensional stability and mechanical strength. In addition, when the silica particles obtained by such a specific process are used in combination with the surface-treating agent for silica particles which will be described later, such as, e.g., a silane coupling agent, and the monomer and/or oligomer thereof which will be described later is added thereto, then there is an advantage that the silica particles can be dispersed in a larger amount without aggregating. Therefore, the radiation-cured product obtained by the invention advantageously has such excellent properties that it combines transparency and other properties including dimensional stability, mechanical strength, and adhesion.

In the invention, the silica particles, especially the silica particles formed in the manner described above, usually frequently are highly polar and compatible with water, alcohols, and the like but are incompatible with the monomer and/or oligomer thereof described later. There is hence a possibility that addition of the monomer and/or oligomer thereof might result in aggregation or opacification. For preventing this, the surface of the silica particles can be protected by a surface treatment according to need.

Namely, a surface-treating agent having a hydrophilic functional group and a hydrophobic functional group is added or otherwise used to thereby hydrophobized the silica particle surface. Compatibility with the monomer and/or oligomer thereof is thus imparted and aggregation and opacification are prevented. A preferred method for the surface treatment is to add a dispersant or surfactant or to modify the surface with a silane coupling agent or the like.

As the dispersant, use may be made of one selected from polymeric dispersants for use in fine-particle dispersions such as various inks, coating materials, and electrophotographic toners. Such a polymeric dispersant to be used is suitably selected from acrylic polymer dispersants, urethane polymer dispersants, etc. Specific examples of trade names of such dispersants include “EFKA” (manufactured by EFKA Additives Inc.), “Disperbyk” (manufactured by Byk-Chemie (BYK) GmbH), and “Disparon” (manufactured by Kusumoto Chemicals Ltd.). The amount of the dispersant to be used is preferably 10-500% by weight, more preferably 20-300% by weight, based on the silica particles.

The surfactant is not particularly limited, and one selected from various high-molecular or low-molecular surfactants for nonaqueous systems, such as cationic, anionic, nonionic, and amphoteric surfactants, can be used. Examples thereof include sulfonamide surfactants (e.g., “Solsperse 3000” manufactured by Avecia Pigments & Additives), hydrostearic acid surfactants (e.g., “Solsperse 17000” manufactured by Avecia Pigments & Additives), fatty acid amine surfactants, ∈-caprolactone surfactants (e.g., “Solsperse 24000” manufactured by Avecia Pigments & Additives), 1,2-hydroxystearic acid polymers, and beef tallow diamine oleic acid salts (e.g., “Duomeen TDO” manufactured by Lion Akzo Co., Ltd.). The amount of the surfactant to be used is preferably 10-500% by weight, more preferably 20-300% by weight, based on the silica particles.

It is especially preferred to treat the surface of silica particles with a silane coupling agent. A silane coupling agent is a compound having a structure comprising a silica atom and, bonded thereto, an alkoxy group and an alkyl group having a functional group. It serves to hydrophobize the surface of silica particles and thereby improve compatibility with other ingredients in the composition or to impart reactivity to the surface of silica particles and thereby improve the mechanical properties of the composition. This silane coupling agent is not particularly limited as long as it accomplishes the purpose. However, a trialkoxysilane having a radiation-curable functional group is preferred, and an alkyltrialkoxysilane is especially preferred. Examples of the former include epoxycyclohexylethyltrimethoxysilane, glycidoxypropyltrimethoxysilane, vinyltrimethoxysilane, vinyltriethoxysilane, acryloyloxypropyltrimethoxysilane, methacryloyloxypropyltrimethoxysilane, mercaptopropyltrimethoxysilane, and mercaptopropyltriethoxysilane. Examples of the latter silane coupling agent include hexyltrimethoxysilane, hexyltriethoxysilane, octyltrimethoxysilane, octyltriethoxysilane, decyltrimethoxysilane, decyltriethoxysilane, octadecyltriethoxysilane, eicosyltriethoxysilane, and triacontyltriethoxysilane, and further include alkoxysilanes having a structure esterified with stearic acid, oleic acid, linoleic acid, linolenic acid, or the like.

In the surface treatment with a silane coupling agent, an alcohol-eliminating reaction basically occurs between an alkoxy group of the silane coupling agent and a hydroxy group on the silica particle surface to form an Si—O—Si bond. However, there are cases where the silane coupling agent undergoes partial hydrolysis during the surface treatment of the silica particles. Consequently, the composition resulting from the surface treatment of silica particles with a silane coupling agent may contain silica particles which have been surface-treated with one or more compounds selected from the group consisting of the silane coupling agent, hydrolyzates of the silane coupling agent, and condensates of these. There also are cases where condensates of the silane coupling agent with itself and/or condensates of the silane coupling agent with hydrolyzates thereof are also present. The hydrolyzates of the silane coupling agent herein mean compounds formed by the conversion of part or all of the alkoxysilane groups contained in the silane coupling agent into hydroxysilanes, i.e., silanol groups, through hydrolysis reaction. In the case where the silane coupling agent is, for example, epoxycyclohexylethyltrimethoxysilane, examples of the hydrolyzates include epoxycyclohexylethylhydroxydimethoxysilane, epoxycyclohexylethyldihydroxymethoxysilane, and epoxycyclohexylethyltrihydroxysilane. Furthermore, the condensates of the silane coupling agent with itself and/or condensates of the silane coupling agent with hydrolyzates thereof are ones yielded by the alcohol-elimination reaction of alkoxy groups with silanol groups and the resultant formation of Si—O—Si bonds or ones yielded by the dehydrating reaction of silanol groups with other silanol groups and the resultant formation of Si—O—Si bonds.

In the invention, the amount of the silane coupling agent to be used is preferably 1% by weight or larger, more preferably 3% by weight or larger, even more preferably 5% by weight or larger, based on the silica particles. The amount thereof is especially preferably 100% by weight or larger, most preferably 200% by weight or larger. When the silane coupling agent is used in too small an amount, there are cases where the surface of the silica particles is not sufficiently hydrophobized and this may arouse a trouble in evenly mixing the particles with a monomer and/or an oligomer thereof. Conversely, too large amounts thereof are undesirable because the silane coupling ingredient not bonded to the silica particles comes into the composition in a large amount and this is apt to produce adverse influences on the transparency, mechanical properties, and other properties of the cured product to be obtained. The amount of the silane coupling agent to be used is preferably 400% by weight or smaller, more preferably 350% by weight or smaller, even more preferably 300% by weight or smaller.

The composition of the invention may contain inorganic ingredients other than silica particles. The optional inorganic ingredients are not particularly limited, and a colorless metal or a colorless metal oxide is, for example, used. Examples thereof include silver, palladium, alumina, zirconia, aluminum hydroxide, titanium oxide, zinc oxide, calcium carbonate, and clay mineral powders. Preferred are alumina, zinc oxide, and titanium oxide. Processes for producing these optional inorganic ingredients are not particularly limited. However, a process in which a commercial product is pulverized with a pulverizer, e.g., a ball mill, a process in which an inorganic ingredient is produced by the sol-gel method, and the like are preferred because particles having a reduced diameter can be obtained. More preferred is the process for production by the sol-gel method. Also in those inorganic ingredients other than silica particles, the particle surface may be protected by a surface treatment according to need.

In the invention, those optional inorganic ingredients preferably are ultrafine particles. The number-average particle diameter thereof is preferably 0.5 nm or larger, more preferably 1 nm or larger. In case where the number-average particle diameter thereof is too small, the ultrafine particles are extremely apt to aggregate and the composition tends to give a cured product considerably reduced in transparency and mechanical strength. In addition, the properties brought about by the quantum effect tend to become insufficient. The number-average particle diameter thereof is preferably 50 nm or smaller, more preferably 40 nm or smaller, even more preferably 30 nm or smaller, especially preferably 15 nm or smaller, most preferably 12 nm or smaller.

Those optional inorganic ingredients may be contained in such an amount that the content of preferably optional-ingredient particles having a particle diameter larger than 30 nm, more preferably optional-ingredient particles having a particle diameter larger than 15 nm, is preferably up to 1% by weight, more preferably up to 0.5% by weight, based on the radiation-curable composition. Alternatively, the content of such inorganic-ingredient particles in the cured product is preferably up to 1% by volume, more preferably up to 0.5% by volume, based on the cured product. Too large contents thereof are undesirable because light scattering is enhanced, resulting in a reduced transmittance. Examples of methods for determining the number-average particle diameters of those ingredients include the same method as described above.

The silica particles and other inorganic ingredients in the radiation-curable composition of the invention have the functions of reducing the temperature dependence of the viscosity of the composition and enhancing the dimensional stability and hardness of the cured product and interlaminar adhesion in multilayer structures. The content thereof is preferably up to 10% by weight, more preferably up to 7% by weight, even more preferably up to 5% by weight, based on the radiation-curable composition. It is most preferred that those inorganic ingredients should not be incorporated.

A monomer and/or oligomer thereof which is not radiation-curable may be further incorporated into the radiation-curable composition of the invention for the purposes of, e.g., improving mechanical properties and heat resistance and balancing various properties. The kind of the monomer and/or oligomer thereof is not particularly limited. For example, one or more monomers for a thermoplastic or thermosetting resin and/or an oligomer thereof is used.

Examples of the thermoplastic resin include polystyrene; poly(methyl methacrylate); polyesters such as polyacrylates and “O-PET” (manufactured by Kanebo, Ltd.); polycarbonates; polyethersulfones; alicyclic thermoplastic resins such as “Zeonex” (manufactured by Nippon Zeon Co., Ltd.) and “Arton” (manufactured by JSR Co, Ltd.); and cyclic polyolefins such as “Apel” (manufactured by Mitsui Chemicals, Inc.). From the standpoints of transparency and dimensional stability, polycarbonates or polyethersulfones are preferred. The amount of the monomer for such a thermoplastic resin and/or oligomer thereof to be used is preferably up to 20% by weight based on the composition excluding all inorganic ingredients. Examples of the monomer for a thermosetting resin and/or oligomer thereof include epoxy resins and “Rigolight” (manufactured by Showa Denko K.K.). A high-purity epoxy resin is preferred from the standpoints of transparency and dimensional stability. The amount of the thermosetting resin to be used is preferably up to 50% by weight based on the composition excluding all inorganic ingredients.

[Properties of the Radiation-Curable Composition]

The radiation-curable composition of the invention has a viscosity as measured at 25° C. of preferably 500 cP or higher, more preferably 1,000 cP or higher, especially preferably 2,000 cP or higher. The viscosity thereof is preferably 15,000 cP or lower, more preferably 10,000 cP or lower, especially preferably 10,000 cP or lower. Viscosities thereof lower than 500 cP are undesirable because it is difficult to form a cured product having a thickness of 50 μm or larger and, hence, this composition cannot be used in applications where such a thick cured product is required, as in, e.g., information recording media. Conversely, viscosities thereof higher than 15,000 cP are undesirable because a cured product having a smooth surface is difficult to form. The viscosity of the composition may be measured with an E-type viscometer, Brookfield viscometer, or vibration viscometer.

Techniques for viscosity regulation include addition of a diluent, addition of a solvent, regulation of the molecular weight of the radiation-curable oligomer, addition of a thickener, and addition of a rheological-property controller. It is preferred to employ addition of a diluent, regulation of the molecular weight of the radiation-curable oligomer, or addition of a thickener. More preferably, addition of a diluent is employed.

For regulating the radiation-curable composition of the invention so as to have a viscosity in that range, it is necessary that the ingredients used for constituting the composition each should have a viscosity as low as possible. For example, when the monomer and/or oligomer having a radiation-curable group has a viscosity of 30,000 cP, then a compound having an ethylenically unsaturated group and having a molecular weight of about 100-250 is used in an amount about 1.5 times by weight the amount of the monomer and/or oligomer, whereby the viscosity of the resultant composition can be regulated to 1,000 cP. By changing the ratio between the amounts of the two ingredients, the viscosity can be regulated. To use a monomer and/or oligomer each having a radiation-curable group and having a molecular weight of 10,000 or lower is also effective. Furthermore, since too low terminal vinyl group contents in the composition result in an elevated viscosity of the composition, it is also effective to regulate the terminal vinyl group content therein so as to be in the range of from 2.0×10⁻³ to 4.3×10⁻³ mol/g. In addition, it is possible to add a thickener such as a clay compound, e.g., an organic bentonite, a polymer, e.g., poly(methyl methacrylate), or the like to regulate the viscosity.

The transparency of the radiation-curable composition itself is not particularly limited as long as the cured product to be obtained by curing the composition is regarded as transparent in the intended use thereof. However, the light transmittance of the composition, as measured at 550 nm over an optical path length of 0.1 mm, is preferably 85% or higher. More preferably, the light transmittance thereof, as measured at 400 nm over an optical path length of 0.1 mm, is 80% or higher, especially 85% or higher. Too low light transmittances thereof are undesirable because the composition during cure tends to have considerably impaired transparency and use of the cured product in an optical recording medium results in an increased number of reading errors in the reading of recorded information.

The radiation-curable composition preferably has a surface tension as measured at 25° C. of 50 mN/m or lower. The surface tension thereof is more preferably 40 mN/m or lower, even more preferably 35 mN/m or lower, especially preferably 30 mN/m or lower. Too high surface tensions thereof are undesirable because the composition shows impaired spreadability during coating and this not only necessitates a larger composition amount for the coating but also is causative of coating defects. The lower the surface tension, the better. However, the surface tension of the composition is generally 10 mN/m or higher. The surface tension of the composition may be measured with a tensiometer (e.g., “Type CBVP-A3” manufactured by Kyowa Interface Science Co., Ltd.). Examples of methods for surface tension regulation include addition of the surface tension regulator.

It is preferred that the radiation-curable composition should contain substantially no solvent. The term “contain substantially no solvent” means the state in which the content of any substance which is the so-called organic solvent having volatility or a low boiling point is exceedingly low. Namely, the solvent content in the composition is generally preferably 5% by weight or lower, more preferably 3% by weight or lower, especially preferably 1% by weight or lower, particularly preferably 0.1% by weight or lower. In a simplified method, the composition which gives off no odor of the organic solvent is regarded as the state in which substantially no solvent is contained.

In the radiation-curable composition of the invention, the content of terminal vinyl groups including (meth)acryloyl, vinyl, and allyl groups is preferably 2.0×10⁻³ mol/g or higher, more preferably 3.0×10⁻³ mol/g or higher, and is preferably 4.3×10⁻³ mol/g or lower, especially preferably 4.0×10⁻³ mol/g or lower. In case where the content of terminal vinyl groups is lower than the lower limit, this composition tends to give a cured product reduced in surface hardness, scratch resistance, etc. On the other hand, in case where the content of terminal vinyl groups exceeds the upper limit, this composition tends to show enhanced cure shrinkage and give a cured product reduced in resistance to heat/humidity. The content of terminal vinyl groups can be determined by a known method. For example, the composition is analyzed by infrared spectroscopy to determine the area of the peak appearing at around 810 cm⁻¹ attributable to the out-of-plane deformation vibration of terminal vinyl C—H and the terminal vinyl content can be determined from the peak area by the working curve method.

In the radiation-curable composition of the invention, the amount of nitrogen atoms contained therein is preferably 1.3×10⁻³ mol/g or larger, more preferably 1.5×10⁻3 mol/g or larger, and is preferably 2.5×10⁻³ mol/g or smaller, especially preferably 2.0×10⁻³ mol/g or smaller. In case where the amount of nitrogen atoms is smaller than the lower limit, this composition is apt to have reduced radiation curability to cause curing failures and tends to give a cured product having reduced adhesion to the substrate. On the other hand, in case where the amount of nitrogen atoms exceeds the upper limit, this composition tends to give a cured product having enhanced water absorption and reduced dimensional stability. The amount of nitrogen atoms can be determined by a known method. For example, use can be made of a method in which a sample is gasified and oxidized in a reaction furnace at a temperature of 800° C. or higher and the nitrogen monoxide generated is determined by a chemiluminescent method.

In the radiation-curable composition of the invention, the content of acid group is preferably 0.1×10⁻⁴ eq/g or higher, more preferably 1.0×10⁻⁴ eq/g or higher, especially preferably 1.5×10⁻⁴ eq/g or higher, and is preferably 13×10⁻⁴ eq/g or lower, more preferably 10×10⁻⁴ eq/g or lower, especially preferably 4.0×10⁻⁴ eq/g or lower. In case where the content of acid groups is lower than the lower limit, this composition tends to give a cured product having reduced adhesion to the substrate. On the other hand, in case where the content of acid groups exceeds the upper limit, this composition tends to give a cured product which is apt to corrode metals. The content of acid groups can be determined by a known method. For example, the content thereof can be determined by the titration method in which an aqueous solvent used for extraction is titrated or the back titration method employing a neutralization reaction with an amine.

### [Production of the Radiation-Curable Composition]

The radiation-curable composition of the invention is prepared by mixing the ingredients described above, i.e., by mixing a monomer having a radiation-curable group and/or an oligomer thereof optionally with other ingredients such as, e.g., a compound having an ethylenically unsaturated group, a reactive diluent, and a polymerization initiator until the mixture becomes homogeneous, while shielding these ingredients from ultraviolet and visible light. Stirring conditions for this mixing are not particularly limited. However, the stirring speed is generally 100 rpm or higher, preferably 300 rpm or higher, and is generally 1,000 rpm or lower. The stirring period is generally 10 seconds or longer, preferably 3 hours or longer, and is generally 24 hours or shorter. Although the stirring temperature generally is ordinary temperature, the ingredients may be heated to a temperature of 90° C. or lower, preferably 70° C. or lower. The sequence of ingredient addition also is not particularly limited. It is, however, preferred to add a high-viscosity liquid ingredient and/or a solid ingredient to a low-viscosity liquid ingredient with stirring. It is also preferred that a polymerization initiator be added last.

Examples of processes for producing the radiation-curable composition of the invention which contains silica particles and other inorganic ingredients include the following. The case where silica particles, among silica particles and other inorganic ingredients, are contained is explained below as a typical example. Processes for production are not particularly limited as long as silica particles are evenly dispersed in and mixed with a mixture of a monomer having a urethane bond and/or an oligomer thereof and other ingredients as optional ingredients Examples thereof include: (1a) a method in which silica particles are prepared, subjected to an appropriate surface treatment, and then directly dispersed in a mixture which comprises the monomer and/or oligomer thereof and other ingredients as optional ingredients and is in an appropriate liquid state; (1b) a method which comprises preparing silica particles, subjecting the particles to an appropriate surface treatment, subsequently directly dispersing the treated particles in the monomer and/or oligomer thereof which is in an appropriate liquid state, and then adding thereto other ingredients as optional ingredients; (2a) a method in which silica particles are synthesized in a mixture which comprises the monomer and/or oligomer thereof and other ingredients as optional ingredients and is in an appropriate liquid state; (2b) a method which comprises synthesizing silica particles in the monomer and/or oligomer thereof which is in an appropriate liquid state and then adding thereto other ingredients as optional ingredients; (3) a method which comprises preparing silica particles in a liquid medium, dissolving the monomer and/or oligomer thereof and other ingredients as optional ingredients in the liquid medium, and then removing the solvent; (4a) a method which comprises dissolving the monomer and/or oligomer thereof and other ingredients as optional ingredients in a liquid medium, preparing silica particles in the liquid medium, and then removing the solvent; (4b) a method which comprises dissolving the monomer and/or oligomer thereof in a liquid medium, preparing silica particles in the liquid medium, subsequently adding thereto other ingredients as optional ingredients, and then removing the solvent; and (5) a method which comprises preparing silica particles and the monomer and/or oligomer thereof in a liquid medium, subsequently adding thereto other ingredients as optional ingredients, and then removing the solvent. Preferred of these are methods (1a), (1b), and (3) because a composition having high transparency and satisfactory storage stability is easy to obtain. More preferred is method (3)

Examples of methods (1a) and (1b) include a method which comprises, in the following order, (A) a step in which silica particles are modified with a surface-treating agent and (B) a step in which the treated silica particles are mixed with a monomer having a urethane bond and/or oligomer thereof and with other ingredients as optional ingredients, and optionally further includes (C) a step in which the solvent is removed from the resultant mixture at a temperature of 10-100° C. By this production process, silica particles are prevented from aggregating to form secondary particles or from enlarging in particle diameter and a radiation-curable composition containing highly dispersed silica particles can be obtained.

In step (A), stirring is conducted at room temperature generally for 0.5-24 hours to allow the reaction to proceed. However, the system may be heated to a temperature not higher than 100° C. Heating heightens the rate of the reaction, whereby the reaction can be carried out in a shorter period. Step (B) should be conducted after the reaction in step (A) has been sufficiently completed. To initiate the operation of step (B) before the reaction in step (A) has not proceeded sufficiently is undesirable because the monomer or oligomer thereof does not mix evenly or the composition opacifies in a later step. Step (B) may be conducted at room temperature. However, this step may be conducted with heating when the monomer and/or oligomer thereof has a high viscosity or has a melting point not lower than room temperature. In step (C), water and a solvent such as an alcohol or ketone are mainly removed. However, to remove these ingredients to a necessary degree suffices and the ingredients need not be completely removed. Too low temperatures are undesirable because solvent removal becomes insufficient. Conversely, too high temperatures are undesirable because the composition is apt to gel.

A preferred example of method (3) comprises, in the following order, (a) a step in which an alkoxysilane oligomer is hydrolyzed at a temperature of 10-100° C. in a liquid medium comprising a solvent, a surface-treating agent or diluent, etc. to synthesize silica particles, (b) a step in which the surface of the silica particles is protected, (c) a step in which the protected silica particles are mixed with a monomer having a urethane bond and/or oligomer thereof and with other ingredients as optional ingredients, and (d) a step in which the solvent is removed at a temperature of 10-75° C. By this production process, a radiation-curable resin composition containing highly dispersed ultrafine silica particles having evenness of particle diameter can be more easily obtained.

In step (a), an alkoxysilane oligomer, a catalyst, and water are added to a liquid medium, and the alkoxysilane oligomer is hydrolyzed to synthesize silica particles in the medium. Although the liquid medium is not particularly limited, it preferably is one which is compatible with the monomer and/or oligomer. For example, a liquid medium comprising a solvent, a surface-treating agent or diluent, etc. is used. The surface-treating agent and the diluent are the same as those described above. As the solvent is preferably used an alcohol or a ketone. It is especially preferred to use a C₁-C₄ alcohol, acetone, methyl ethyl ketone, or methyl isobutyl ketone. The amount of the liquid medium to be used is preferably 0.3-10 times the amount of the alkoxysilane oligomer.

As the catalyst is used a hydrolysis catalyst such as an organic acid, e.g., formic acid or maleic acid, an inorganic acid, e.g., hydrochloric acid, nitric acid, or sulfuric acid, a metal complex compound, e.g., acetylacetone aluminum, dibutyltin dilaurate, or dibutyltin dioctanoate, or the like. The amount of the catalyst to be used is preferably 0.1-3% by weight based on the alkoxysilane oligomer. Water is added preferably in an amount of 10-50% by weight based on the alkoxysilane oligomer. The hydrolysis is conducted at a temperature of 10-100° C. Temperatures lower than the lower limit are undesirable because the reaction for forming silica particles does not proceed sufficiently. Conversely, too high temperatures are undesirable because the oligomer is apt to undergo a gel-forming reaction. The period of hydrolysis is preferably from 30 minutes to 1 week.

The reaction in step (b) is for protecting the surface of the silica particles. A surface-protective agent is used in this step, and examples thereof include surfactants, dispersants, and silane coupling agents. In the case of using a surfactant or a dispersant, examples of methods for the step include: a method in which the surface-protective agent is added and the resultant mixture is stirred at a temperature of from room temperature to 60° C. for about from 30 minutes to 2 hours to react the protective agent; and a method in which after the surface-protective agent is added and reacted, the resultant reaction mixture is aged at room temperature for several days. It is important that the solvent to be selected for the addition should not be one in which the surface-protective agent has exceedingly high solubility. Use of a solvent in which the surface-protective agent has exceedingly high solubility is undesirable because the inorganic ingredient is not sufficiently protected or the protection process requires much time. In the case of solvents in which the surface-protective agent has exceedingly high solubility, there frequently are cases where use of a solvent differing in solubility parameter value (SP value) from the surface-treating agent by 0.5 or more enables the inorganic ingredient to be sufficiently protected.

In the case of using a silane coupling agent, the surface protection reaction proceeds at room temperature (25° C.). Although the system is generally stirred for 0.5-24 hours to allow the reaction to proceed, it may be heated to a temperature not higher than 100° C. Heating heightens the rate of the reaction, whereby the reaction can be carried out in a shorter period. However, there are cases where the silane coupling agent at high temperatures undergoes polymerization with itself to cause opacification. Consequently, the temperature at which the system is heated is preferably 90° C. or lower, more preferably 80° C. or lower, even more preferably 70° C. or lower.

Although no addition of water to the system is preferred in the case of using a silane coupling agent, water may be added. In this case, however, addition of water in an excessively large amount poses a problem that hydrolysis and water-eliminating condensation reactions proceed when the surface of the silica particles is in an insufficiently protected state, and this is causative of opacification or gelation of the composition. Especially when the composition has a high silica particle concentration, care should be taken because this composition highly tends to opacify or gel. The amount of the water to be added is preferably 30% by mole or larger, more preferably 50% by mole or larger, even more preferably 70% by mole or larger, and is preferably 130% by mole or smaller, more preferably 120% by mole or smaller, even more preferably 110% by mole or smaller, based on the amount necessary for hydrolyzing the alkoxy groups derived from the silane coupling agent and the residual alkoxy groups derived from the alkoxysilane. The silane coupling agent may be added in two or more portions. In the case of using a silane coupling agent, it is preferred to add a catalyst in order to accelerate the hydrolysis of alkoxy groups and the formation of silanol bonds. As the catalyst may be used a known catalyst for dehydrating condensation reactions. Preferred of these are tin compounds such as dibutyltin dilaurate and dibutyltin dioctoate.

Step (c) should be conducted after the reaction in step (b) has been sufficiently completed. The completion of the reaction in step (b) can be ascertained through a measurement of the amount of the silane coupling agent remaining in the reaction mixture. In general, step (c) is initiated when the amount of the silane coupling agent remaining in the reaction mixture has decreased to or below 10% of the amount of the silane coupling agent supplied. To initiate the operation of step (c) before the reaction in step (b) has not proceeded sufficiently is undesirable because the monomer or oligomer does not mix evenly or the composition opacifies in a later step. Step (c) may be conducted at room temperature (25° C.) However, this step may be conducted with heating at 30-90° C. when the monomer or oligomer has a high viscosity or has a melting point not lower than room temperature (25° C.) The period of mixing is preferably from 30 minutes to S hours.

In step (d), solvents such as the solvent used as a liquid medium and the alcohol generated by the hydrolysis of the alkoxysilane oligomer are mainly removed. However, to remove such solvents to a necessary degree suffices and the solvents need not be completely removed. It is preferred that the solvents be removed to about the same degree as in the composition containing substantially no solvent described above. Temperatures lower than the lower limit shown above are undesirable because solvent removal is insufficient. Conversely, too high temperatures are undesirable because the composition is apt to gel. The temperature may be controlled stepwise. The period of removal is preferably 1-12 hours. It is preferred to remove the solvents at a reduced pressure which is 20 kPa or lower, more preferably 10 kPa or lower, and is 0.1 kPa or higher. The pressure may be gradually reduced.

Compared to the method in which a filler (e.g., silica particles) and a surface-treating agent such as, e.g., a silane coupling agent are added later to a composition and the filler is dispersed, the preferred production processes described above have an advantage that ultrafine particles having a smaller particle diameter can be dispersed in a large amount while preventing the ultrafine particles from aggregating. Consequently, the radiation-curable composition obtained contains silica particles dispersed therein in an amount suitable for reducing cure shrinkage and enhancing the mechanical strength of the cured product without impairing radiation-transmitting properties. The cured product obtained by curing this composition has advantages that it combines transparency, reduced cure shrinkage, and mechanical strength and further combines high surface hardness and resistance to deformation by heat/humidity.

### [Production of Radiation-Cured Product]

The cured product of the radiation-curable composition is obtained through the so-called “radiation curing” in which the composition is irradiated with a radiation (e.g., actinic energy rays or electron beams) to initiate a polymerization reaction. Modes of the polymerization reaction are not limited, and a known polymerization mode can be used, such as, e.g., radical polymerization, anionic polymerization, cationic polymerization, or coordination polymerization. Radical polymerization is the most preferred polymerization mode among these polymerization modes shown as examples. Although the reasons for the preference of radical polymerization are uncertain, it is presumed that the initiation of polymerization reaction in this mode proceeds homogeneously in a short time period in the polymerization system and this brings about homogeneity of the product.

The radiation is an electromagnetic wave (e.g., gamma rays, X-rays, ultraviolet, visible light, infrared, or microwave) or corpuscular rays (e.g., electron beams, α-rays, neutron rays, or any of various atomic beams) which each serve to act on the polymerization initiator initiating the desired polymerization reaction and thereby cause the initiator to generate a chemical species which initiates the polymerization reaction. Preferred examples of radiations for use in the invention include ultraviolet, visible light, and electron beams because a general light source can be used as an energy source. Ultraviolet and electron beams are most preferred.

In the case of using ultraviolet, a method is employed in which a photo-radical generator (examples of which were shown hereinabove) which generates a radical by the action of ultraviolet is used as a polymerization initiator in combination with ultraviolet as a radiation. A sensitizer may be used in this case according to need. The ultraviolet has wavelengths in the range of generally 200-400 nm, preferably 250-400 nm. As a device for emitting ultraviolet, a known device can be advantageously used, such as a high-pressure mercury lamp, a metal halide lamp, or an ultraviolet lamp of the structure which generates ultraviolet by the action of microwaves. A high-pressure mercury lamp is more preferred. The output of the device is generally 10-200 W/cm. It is preferred that the device be disposed at a distance of 5-80 cm from the substance to be irradiated because the substance being thus irradiated is less apt to suffer light deterioration, heat deterioration, heat deformation, etc.

It is also preferred to cure the composition of the invention with electron beams. A cured product having excellent mechanical properties, in particular excellent tensile elongation characteristics, can be thus obtained. In the case of using electron beams, an expensive light source and an expensive irradiator are necessary. However, there are cases where electron beam irradiation is advantageously used because the addition of an initiator can be omitted and because polymerization inhibition by oxygen can be avoided and satisfactory surface hardness can hence be obtained. The types of electron beam irradiators usable for electron beam irradiation are not particularly limited, and examples thereof include the curtain type, area beam type, broad beam type, and pulse beam type. The accelerating voltage in electron beam irradiation is preferably 10-1,000 kV.

Irradiation with those radiations is conducted in a light intensity of generally 0.1 J/cm² or more, preferably 0.2 J/cm² or more. The light intensity is generally 20 J/cm² or less, preferably 10 J/cm² or less, more preferably 5 J/cm² or less, even more preferably 3 J/cm² or less, especially preferably 2 J/cm² or less. A light intensity within this range can be suitably selected according to the kind of the radiation-curable composition. In the case where the radiation-curable composition contains a monomer having a urethane bond and/or an oligomer thereof, the light intensity thereof is preferably 2 J/cm² or less. In the case where the radiation-curable composition contains a monomer comprising a fused alicyclic acrylate and/or an oligomer thereof, the light intensity thereof is preferably 3 J/cm² or less.

When the irradiation energy of the radiation is extremely low or the irradiation period is extremely short, there are cases where the polymerization is incomplete and the resultant radiation-cured product is hence insufficient in heat resistance and mechanical properties. The irradiation is conducted for a period of generally 1 second or longer, preferably 10 seconds or longer. Conversely, however, excessive irradiation may cause deterioration represented by the yellowing and other hue deterioration caused by light. Consequently, the irradiation period is generally 3 hours or shorter and is preferably about 1 hour or shorter from the standpoints of reaction acceleration and productivity.

The irradiation with a radiation may be conducted in one stage or in two or more stages. A diffusing radiation source which emits a radiation in all directions is generally used. Usually, the polymerizable liquid composition which has been formed into a given shape in a mold is irradiated while keeping the composition stationary or conveying it with a conveyor and keeping the radiation source in a fixed state. It is also possible to use a method in which the polymerizable liquid composition is applied to an appropriate substrate (e.g., a resin, metal, semiconductor, glass, or paper) to obtain a liquid coating film and this liquid coating film is then cured by irradiation with a radiation.

### [Properties of the Radiation-Cured Product]

The radiation-cured product of the invention generally has the property of being insoluble in solvents and being infusible. Even when formed so as to have a large thickness, the cured product preferably has properties advantageous in optical-member applications and excellent in adhesion and surface hardness. Specifically, the cured product preferably has reduced optical distortion (low birefringence), high light transmittance, mechanical strength, dimensional stability, high adhesion, high surface hardness, and at least a certain level of resistance to deformation by heat/humidity. The lower the cure shrinkage, the more the cured product is preferred.

The radiation-cured product of the invention generally has a film thickness of 5 cm or smaller. The thickness thereof is preferably 1 cm or smaller, more preferably 1 mm or smaller, even more preferably 500 μm or smaller, and is generally 20 μm or larger, preferably 30 μm or larger, more preferably 50 μm or larger, especially preferably 80 μm or larger.

The radiation-cured product of the invention, when having been obtained through irradiation with ultraviolet in a light intensity of 1 J/cm², has the following properties (1) to (3):

(1) when the cured product has a thickness of 100±5 μm, the cured product has a light transmittance, as measured at a wavelength of 550 nm, of 80% or higher;
(2) a multilayer structure where the cured product having a thickness of 100±5 μm is formed on a poly(ethylene terephthalate) film having a thickness of 100±5 μm, has a surface hardness of 2 B or higher; and
(3) when a multilayer structure where the cured product having a thickness of 100±5 μm is formed on a disk made of a polycarbonate having a diameter of 130 mm and a thickness of 1.2±0.2 mm, is placed in an environment of 80° C. and 85% RH for 100 hours, then an absolute value |a| of an amount of warpage, a (mm), as measured on the circumference of the multilayer structure is 0.5 mm or less.

The light transmittance in (1) is light transmittance per optical path length of 0.1 mm as measured at a wavelength of 550 nm. The light transmittance of the cured product of the invention is 80% or higher, preferably 85% or higher, more preferably 89% or higher. In case where the light transmittance thereof is lower than the lower limit, this cured product has poor transparency and use of this cured product in, e.g., optical recording media results in an increased number of errors in the reading of recorded information. More preferably, the light transmittance of the cured product per optical path length of 0.1 mm, as measured at a wavelength of 400 nm, is preferably 80% or higher, more preferably 85% or higher, especially preferably 89% or higher. The light transmittance of the cured product may be measured, for example, with ultraviolet/visible light absorptiometer Type HP8453, manufactured by Hewlett-Packard Co., at room temperature.

For regulating the cured product of the invention so as to have a light transmittance within that range, it is preferred that ingredients having a high light transmittance be employed as the ingredients for constituting the composition. Furthermore, each ingredient preferably is one reduced in the content of impurities such as colored substances and decomposition products or one produced using a small amount of a catalyst. Use of such ingredients is effective in preventing the light transmittance in the visible region from decreasing. It is also preferred to select compounds having an aliphatic or alicyclic skeleton and containing no aromatic ring. Use of such compounds is effective in preventing the light transmittance in the ultraviolet region from decreasing.

The surface hardness in (2) is the surface hardness as measured by the pencil hardness test in accordance with JIS K5400. The cured product of the invention has a surface hardness of preferably 2 B or higher, more preferably B or higher, even more preferably HB or higher.

For regulating the cured product of the invention so as to have a surface hardness within that range, it is preferred to heighten the crosslink density of the cured product, for example, by using a compound having a functionality of 2 or higher as the compound having ethylenically unsaturated groups or by regulating the terminal vinyl group content in the composition to 20×10⁻³ or higher. It is also preferred that the monomer and/or oligomer having a radiation-curable group to be used should be one which has a rigid skeleton. For example, in the case where the monomer and/or oligomer is one having urethane bonds, it is preferred that a polycarbonate polyol or a polyether polyol, more preferably a polycarbonate polyol, be used as the polyol ingredient for the monomer and/or oligomer and/or that a polyol having a molecular weight of 1,000 or lower be used as the polyol ingredient. Use of a polyol having a stiff structure, e.g., a bisphenol A skeleton, is also effective.

The resistance to deformation by heat/humidity in (3) is evaluated in the following manner. After the disk-shaped multilayer structure is placed in an environment of 80° C. and 85% RH for 100 hours, the multilayer structure is placed on a flat plate and examined for the amount of warpage (mm) in terms of the distance between the whole circumference and the flat plate. The warpage amount is measured with respect to each of four points on the circumference of the disk-shaped multilayer structure which divide the circumference into four equal arcs; the average of these found values is referred to as “a” (mm). This multilayer structure is subsequently placed in an environment of 23° C. and 65% RH for 168 hours and then examined in the same manner; the average of the four found values is referred to as “b” (mm). The absolute value of a, i.e., |a|, is preferably 0.5 mm or less, especially preferably 0.30 mm or less, most preferably 0.25 mm or less. The absolute value of b, i.e., |b|, is 0.5 mm or less, preferably 0.30 mm or less, more preferably 0.25 mm or less. Furthermore, the absolute value of (b−a), i.e., |b−a|, is preferably 0.20 mm or less, more preferably 0.10 mm or less.

In case where the value of |a| exceeds the upper limit, errors tend to arise during information reading and writing due to the substrate warpage. In case where the value of |b| exceeds the upper limit, further formation of a hard coat layer as a cured product on the surface of the cured product layer according to the invention leads to damages such as, e.g., peeling or cracking of the hard coat layer. Furthermore, in case where the value of |b−a| is larger than the upper limit, further formation of a hard coat layer as a cured product on the surface of the cured product layer according to the invention tends to result in damages such as, e.g., peeling or cracking of the hard coat layer.

For regulating the cured product of the invention so that the resistance thereof to deformation by heat/humidity is within those ranges, it is preferred that the monomer and/or oligomer having a radiation-curable group to be used should be one which has a flexible skeleton. For example, in the case where the monomer and/or oligomer is one having urethane bonds, it is preferred to use a polyester polyol as the polyol ingredient for the monomer and/or oligomer and/or to use a polyol having a high molecular weight as the polyol ingredient. It is also preferred to use a monomer and/or oligomer having urethane bonds which has been produced using a reduced amount of a low-molecular diol ingredient so as to have a reduced hard-segment amount. Furthermore, it is preferred to regulate the cured product so as to have a crosslink density which is not so high, for example, by reducing the amount of a compound having a functionality of 2 or higher to be used as the compound having ethylenically unsaturated groups or by regulating the terminal vinyl group content in the composition to 4.3×10⁻³ mol/g or lower. It is also effective to lower the water absorption of the cured product, for example, by using ingredients having a low water absorption as the ingredients for constituting the composition. In addition, it is effective to use a (meth)acrylate having a bulky alicyclic skeleton as a reactive diluent in the composition. It is preferred that a polymerization initiator be used in a reduced amount to thereby diminish the initiator remaining in the composition.

In order to simultaneously attain the viscosity of the radiation-curable composition of the invention and the light transmittance, surface hardness, and resistance to deformation by heat/humidity of the cured product obtained therefrom, use is made of a monomer and/or oligomer having a radiation-curable group which has a low viscosity and has a skeleton having a balance between flexibility and rigidity. For example, in the case where the monomer and/or oligomer having a radiation-curable group is one having urethane bonds, it is preferred for attaining those properties that a combination of a polyether polyol and a polyester polyol or a combination of a polycarbonate polyol and a polyester polyol be used as a polyol ingredient for the monomer and/or oligomer. Although a polyether polyol and a polycarbonate polyol have a rigid skeleton, a balance with flexibility can be attained by using them in combination with a flexible polyester polyol. For example, the proportion of polyether polyol skeletons and that of polyester polyol skeletons are regulated to 20-90% by weight and 10-80% by weight, respectively, based on all polyol skeletons. The monomer and/or oligomer having urethane bonds to be used preferably is one which has a molecular weight of 10,000 or lower. It is also effective to use a (meth)acrylate having a bulky alicyclic skeleton as a reactive diluent for the composition in an amount in the range of 0.1-30% by weight based on the composition and to regulate the content of terminal vinyl groups in the composition so as to be in the range of from 2.0×10⁻³ to 4.3×10⁻³ mol/g. It is preferred to use a polymerization initiator in an amount in the range of from 0.001 part by weight to 10 parts by weight per 100 parts by weight of the monomer and/or oligomer having a radiation-curable group.

The radiation-cured product of the invention further has excellent adhesion to the substrate. For example, when a multilayer structure composed of a substrate and a layer of the cured product having a thickness of 100±15 μm formed thereon is placed in an environment of 80° C. and 85% RH for 100 hours, preferably 200 hours, then the proportion of the area where the cured product layer is adherent to the substrate is preferably 50% or higher, more preferably 80% or higher, especially preferably 100%, based on the initial adhesion area.

The radiation-cured product of the invention, when formed into a thick film, preferably has no cracks or the like and has mechanical strength not lower than a certain level. For example, when a layer of the cured product having a thickness of 100±5 μm is formed, the tensile strength at break thereof is preferably 20 MPa or higher, more preferably 25 MPa or higher, especially preferably 30 MPa or higher.

The radiation-cured product of the invention, when having been obtained through ultraviolet irradiation in a light intensity of 1 J/cm², has a water absorption, as measured by method A in accordance with JIS K7209, of preferably 2% by weight or lower, more preferably 1.5% by weight or lower, especially preferably 1.0% by weight or lower. In case where the water absorption thereof exceeds the upper limit, this cured product not only tends to have reduced resistance to deformation in high-temperature high-humidity environments but is apt to corrode metals.

The radiation-cured product of the invention further has reduced cure shrinkage. The cure shrinkage thereof is, for example, preferably 3% by volume or less, more preferably 2% by volume or less. The cured product furthermore shows reduced thermal expansion. For example, when a platy test piece having dimensions of 5 mm×5 mm×1 mm is examined with a thermomechanical analyzer (TMA; Type SSC/5200; manufactured by Seiko Instrument Inc.) by the compression method under the conditions of a load of 1 g and a heating rate of 10° C./min over the range of from 40° C. to 100° C. at an interval of 10° C. and the coefficient of linear expansion thereof is calculated as an average for these measurements, then the coefficient of thermal expansion thereof is preferably 13×10⁻⁵/° C. or lower, more preferably 12×10⁻⁵/° C. or lower, even more preferably 10×10⁻⁵/° C. or lower, especially preferably 8×10⁻⁵/° C. or lower. The cured product still further has excellent heat resistance, and the glass transition temperature thereof is preferably 120° C. or higher, more preferably 150° C. or higher, even more preferably 170° C. or higher. The cured product furthermore has excellent solvent resistance. For example, it has satisfactory resistance to solvents such as toluene, chloroform, acetone, and tetrahydrofuran.

The cured product of the invention may contain inorganic fine particles such as, e.g., silica particles. However, since these fine particles differ in optical properties from the resin matrix, which is an organic substance, there are cases where the cured product as a whole has a peculiar balance between refractive index and Abbe's number which is not realized with the organic substance alone. This peculiar balance between refractive index and Abbe's number can be useful in applications where light refraction by a lens, prism, or the like is utilized and small birefringence is desirable. Specifically, such applications are ones in which the refractive index n_{D} and Abbe's number ν_{D} determined at 23° C. with sodium D-line are represented by the following expression wherein the constant term C is outside the range of 1.70-1.82.

n_{D}=0.005ν_{D}+C

In molded resin materials, the birefringence thereof generally increases with increasing thickness. In the invention, there are cases where due to the use of the silica particles, the cured product of the invention is characterized in that the increase in birefringence with increasing thickness is smaller than in resin material moldings heretofore in use. Consequently, use of the cured product of the invention as a relatively thick molding having a thickness of 0.1 mm or larger, such as optical members according to the invention which will be described later, is advantageous from the standpoint of birefringence reduction.

[Applications of the Radiation-Cured Product]

The radiation-cured product of the invention is highly suitable for use as an optical material because it is reduced in optical distortion represented by birefringence, has satisfactory transparency, and further has excellent functional properties such as dimensional stability and surface hardness. The term optical material herein means any of general moldings for use in applications where optical properties of components of the moldings are utilized, such as, e.g., transparency, extinction/emission characteristics, a refractive-index difference between the component and the surrounding atmosphere, smallness of birefringence, and the peculiar balance between refractive index and Abbe's number. Examples thereof include members for optics and optoelectronics such as display panels, touch panels, lenses, prisms, waveguides, and light amplifiers.

Optical materials according to the invention are roughly divided into two groups. Optical materials in the first group are optical materials which each are a molding comprising the cured product, while optical materials in the second group are optical materials which each are a molding comprising layers including a thin film of the cured product. Namely, the former optical materials are ones which consist mainly of the cured product and may have any desired thin film (coating layer) made of a material which is not the cured product. On the other hand, the latter optical materials are ones consisting mainly of a material which need not be the cured product and having a thin film of the cured product as part of the layers. Each optical material may be one formed adherently to any desired solid substrate such as, e.g., a resin, glass, ceramic, inorganic crystal, metal, semiconductor, diamond, organic crystal, paper pulp, or wood.

The optical materials in the first group are not particularly limited in dimensions. However, the lower limit of the optical path length in the cured product part is generally 0.01 mm, preferably 0.1 mm, more preferably 0.2 mm, from the standpoint of the mechanical strength of the optical material. On the other hand, the upper limit thereof is generally 10,000 mm, preferably 5,000 mm, more preferably 1,000 mm, from the standpoint of light intensity attenuation. The shapes of the optical materials in the first group are not particularly limited. Examples thereof include a flat plate shape, curved plate shape, lens shape (e.g., concave lens, convex lens, concave/convex lens, one-side-concave lens, or one-side-convex lens), prism shape, and fiber shape.

The optical materials in the second group are not particularly limited in dimensions. However, the lower limit of the thickness of the thin cured product film is generally 0.05 μm, preferably 0.1 μm, ore preferably 0.5 μm, from the standpoints of mechanical strength and optical properties. On the other hand, the upper limit of the thickness thereof is generally 3,000 μm, preferably 2,000 μm, more preferably 1,000 μm, from the standpoints of thin-film formability and a balance between cost and effect. The shape of the thin film is not limited and need not be flat. For example, the thin film may have been formed on a substrate of any desired shape such as, e.g., a spherical shape, aspheric curved shape, cylindrical shape, conical shape, or bottle shape.

Any desired coating layers may be formed on the optical materials of the invention according to need to make the optical materials have a multilayer structure. Namely, any desired functional layers may be formed, such as, e.g., a protective layer which prevents a coating from being mechanically damaged by friction or wearing, a light absorption layer which absorbs light of undesirable wavelengths causative of the deterioration of semiconductor crystal particles, the substrate, etc., a barrier layer which inhibits or prevents reactive low-molecular substances such as moisture and oxygen gas from passing therethrough, an antiglare layer, an antireflection layer, a low-refractive-index layer, an undercoat layer which improves adhesion between the substrate and a coating, or an electrode layer. Examples of such optional coating layers include a transparent electroconductive film or gas barrier film each comprising an inorganic oxide coating layer and a gas barrier film or hard coat each comprising an organic coating layer. For forming these layers, known coating techniques can be used, such as e.g., vacuum deposition, CVD, sputtering, dip coating, and spin coating.

More specific examples of the optical materials according to the invention include various lenses such as spectacle lenses, microlenses for optical connectors, and condenser lenses for light-emitting diodes; parts for optical communication, such as light switches, optical fibers, optical branch/connection circuits and optical multiplex branch circuits in optical circuits, and light intensity regulators; members for various displays, such as substrates for liquid crystals, touch panels, lightguide plates, and retardation plates; members for memory/recording applications, such as optical-disk substrates and films/coatings for optical disks; various materials for optical communication, such as optical adhesives; and various optical film/coating applications such as functional films, antireflection films, optical multilayered films (e.g., selective reflecting films and selective transmitting films), ultra-resolution films, ultraviolet-absorbing films, reflection control films, lightguides, and printed surfaces having the function of identifying

### [Optical Recording Medium]

The optical recording medium in the invention is not particularly limited. However, it preferably is a next-generation high-density optical recording medium for which a blue laser light is used. This optical recording medium means an optical recording medium which comprises a substrate, layers formed thereon including a dielectric layer, recording layer, and reflecting layer (hereinafter, these layers are inclusively referred to as a recording/reproducing functional layer), and a protective film formed on the surface of the recording/reproducing functional layer, and for which a laser light having a wavelength of 380-800 nm, preferably a laser light having a wavelength of 450-350 nm, is used.

The substrate is then explained. The substrate has, on one of its main sides, grooves for recording/reproducing optical information. This substrate is formed, for example, by the injection molding of a light-transmitting resin with a stamper. The material of the substrate is not particularly limited as long as it is a light-transmitting material. For example, thermoplastic resins such as polycarbonate resins, polymethacrylate resins, and polyolefin resins and glasses can be used. Polycarbonate resins are most preferred of these because polycarbonate resins are most extensively used in CD-ROM and others and are inexpensive. The thickness of the substrate is generally 0.1 mm or larger, preferably 0.3 mm or larger, more preferably 0.5 mm or larger, and is generally 20 mm or smaller, preferably 15 mm or smaller, more preferably 3 mm or smaller. In general, however, the thickness thereof is about 1.2±0.2 mm. The outer diameter of the substrate is generally about 120 mm.

The recording/reproducing functional layer is a layer constituted so as to have the function of being capable of recording/reproducing information signals or of reproducing information signals. It may consist of a single layer or may be composed of two or more layers. The recording/reproducing functional layer may have a layer constitution suitable for purposes according to the case where the optical recording medium is a medium for reproduction only (ROM medium), the case where the optical recording medium is a recordable medium in which recording is possible only once (write-once medium), and the case where the optical recording medium is a rewritable medium in which recording and deletion can be repeatedly conducted (rewritable medium).

In the medium for reproduction only, for example, the recording/reproducing functional layer is generally constituted of a single layer comprising a metal such as Al, Ag, or Au. This recording/reproducing functional layer is formed, for example, by depositing a reflecting layer of Al, Ag, or Au on a substrate by sputtering.

In the recordable medium, the recording/reproducing functional layer is generally constituted by forming a reflecting layer comprising a metal such as Al, Ag, or Au and a recording layer containing an organic dye on a substrate in this order. Examples of the recordable medium of this constitution include one obtained by depositing a reflecting layer by sputtering and then forming a layer of an organic dye over the substrate by spin coating. Another example of the recordable medium has a recording/reproducing functional layer constituted of a reflecting layer comprising a metal such as Al, Ag, or Au, a dielectric layer, a recording layer, and a dielectric layer which have been formed on a substrate in this order, wherein the dielectric layers and the recording layer contain an inorganic material. In producing this recordable medium, the reflecting layer, dielectric layer, recording layer, and dielectric layer are formed generally by sputtering.

In the rewritable medium, the recording/reproducing functional layer is generally constituted by forming a reflecting layer comprising a metal such as Al, Ag, or Au, a dielectric layer, a recording layer, and a dielectric layer on a substrate in this order and the dielectric layers and the recording layer generally contain an inorganic material. In producing this rewritable medium, the reflecting layer, dielectric layer, recording layer, and dielectric layer are formed generally by sputtering. Another example of the rewritable medium is an optomagnetic recording medium, in which the recording/reproducing functional layer has a recording/reproducing region. The recording/reproducing region is generally disposed in an area having an inner diameter larger than that of the recording/reproducing functional layer and having an outer diameter smaller than that of the recording/reproducing functional layer.

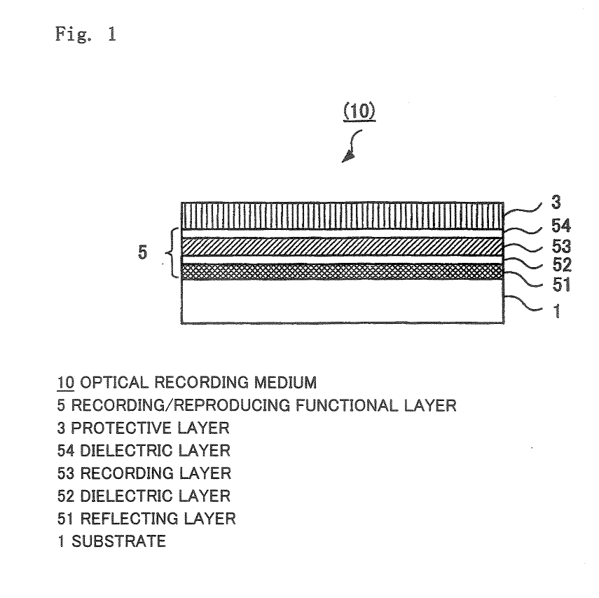

FIG. 1 is a sectional view illustrating one example of a recording/reproducing functional layer 5 in an optical recording medium 10 of the rewritable type. The recording/reproducing functional layer 5 is constituted of a reflecting layer 51 formed directly on a substrate 1 and made of a metallic material, a recording layer 53 made of a phase-change type material, and two dielectric layers 52 and 54 disposed so as to sandwich the recording layer 53 therebetween.

The material to be used for forming the reflecting layer 51 preferably is a substance having a high reflectance. Especially preferred is a metal such as Au, Ag, or Al, which are expected to produce a heat dissipation effect. A metal such as, e.g., Ta, Ti, Cr, Mo, Mg, V, Nb, Zr, or Si may be added thereto in a small amount in order to regulate the thermal conductivity of the reflecting layer itself or to improve corrosion resistance. The amount of such a metal to be added in a small amount is generally from 0.01 at. % to 20 at. %. In particular, an aluminum alloy containing Ta and/or Ti in an amount of 15 at. % or smaller, especially an alloy represented by Al₁₋ₓTaₓ (0≦x≦0.15), has excellent corrosion resistance and is an especially preferred reflecting-layer material useful for improving the reliability of the optical recording medium. Furthermore, a silver alloy comprising Ag and 0.01-10 at. % one member selected from Mg, Ti, Au, Cu, Pd, Pt, Zn, Cr, Si, Ge, and the rare-earth elements is preferred because it has a high reflectance, high thermal conductivity, and excellent heat resistance.

The thickness of the reflecting layer 51 is generally 40 nm or larger, preferably 50 nm or larger, and is generally 300 nm or smaller, preferably 200 nm or smaller. In case where the thickness of the reflecting layer 51 is excessively large, the shape of the grooves for tracking formed in the substrate 1 may change and the film deposition tends to require much time and result in an increased material cost. On the other hand, in case where the thickness of the reflecting layer 51 is excessively small, not only light transmission occurs to prevent the layer from functioning as a reflecting layer, but also an island structure formed in the early stage of film deposition is apt to influence part of the reflecting layer 51 and this may result in a decrease in reflectance or thermal conductivity.

The material to be used for the two dielectric layers 52 and 54 serves to prevent the phase changes of the recording layer 53 from causing vaporization/deformation and to control heat diffusion in the phase changes. The material of the dielectric layers is selected while taking account of refractive index, thermal conductivity, chemical stability, mechanical strength, adhesion, etc. In general, use can be made of a dielectric material having high transparency and a high melting point, such as, e.g., an oxide, sulfide, nitride, or carbide of one or more metals or semiconductors or a fluoride of Ca, Mg, Li, or the like. The oxide, sulfide, nitride, carbide, and fluoride each need not have a stoichiometric composition, and may have a regulated composition so as to have a controlled refractive index, etc. Use of a mixture of two or more of these materials is also effective.

Examples of such dielectric materials include oxides of metals such as Sc, Y, Ce, La, Ti, Zr, Hf, V, Nb, Ta, Zn, Al, Cr, In, Si, Ge, Sn, Sb, and Te; nitrides of metals such as Ti, Zr, Hf, V, Nb, Ta, Cr, Mo, W, Zn, B, Al, Ga, In, Si, Ge, Sn, Sb, and Pb; carbides of metals such as Ti, Zr, Hf, V, Nb, Ta, Cr, Mo, W, Zn, B, Al, Ga, In, and Si; and mixtures of these. Examples thereof further include sulfides of metals such as Zn, Y, Cd, Ga, In, Si, Ge, Sn, Pb, Sb, and Bi; selenides or tellurides of these metals; fluorides of Mg and Ca; and mixtures of these.

When suitability for repetitions of recording is taken into account, a mixture of dielectrics is preferred. Examples thereof include mixtures of a chalcogen compound, e.g., ZnS or a rare-earth sulfide, and a refractory compound such as an oxide, nitride, carbide, or fluoride. For example, a refractory-compound mixture containing ZnS as a main component and a refractory-compound mixture containing a rare-earth sulfide, especially Y₂O₂S, as a main component are preferred examples of dielectric layer compositions. Specific examples thereof include ZnS—SiO₂, SiN, SiO₂, TiO₂, CrN, TaS₂, and Y₂O₂S. Of these materials, ZnS—SiO₂ is extensively used because of its high film deposition rate, low film stress, small volume change with changing temperature, and excellent weatherability. The thickness of each of the dielectric layers 52 and 54 is generally 1 nm or larger and 500 nm or smaller. When the thickness thereof is 1 nm or larger, the effect of preventing the substrate and the recording layer from deforming can be sufficiently secured and the dielectric layers can sufficiently perform their function. When the thickness of each dielectric layer is 500 nm or smaller, the dielectric layers can be prevented from coming to have a significantly increased internal stress, a considerably increased difference in elasticity between themselves and the substrate, etc. and thus cracking, while sufficiently functioning as dielectric layers.

Examples of the material for forming the recording layer 53 include compounds having compositions such as GeSbTe, InSbTe, AgSbTe, and AgInSbTe. In particular, a thin film comprising as the main component an alloy represented by {(Sb₂Te₃)₁₋ₓ(GeTe)ₓ}_{1-y}Sb_{y} (wherein 0.2≦x≦0.9 and 0≦y≦0.1) or an alloy represented by (SbₓTe₁₋ₓ)_{y}M_{1-y} (wherein 0.6≦x≦0.9, 0.7≦y≦1, and M is at least one member selected from Ge, Ag, In, Ga, Zn, Sn, Si, Cu, Au, Pd, Pt, Pb, Cr, Co, O, S, Se, V, Nb, and Ta) is stable in either a crystalline or an amorphous state and is capable of high-speed phase changes between the two states. It further has an advantage that segregation is less apt to occur during repetitions of overwriting. It is hence a most practical material.

The thickness of the recording layer 53 is generally 5 nm or larger, preferably 10 nm or larger. When the recording layer is formed in such a thickness, a sufficient optical contrast between the amorphous state and crystalline state can be obtained. Furthermore, the thickness of the recording layer 53 is generally 30 nm or smaller, preferably 20 nm or smaller. When the recording layer 53 is formed in such a thickness, light transmission through the recording layer 53 occurs and the transmitted light is reflected by the reflecting layer, whereby an increased optical contrast can be obtained. In addition, heat capacity can be regulated to an appropriate value to enable high-speed recording. Especially when the thickness of the recording layer 53 is regulated so as to be from 10 nm to 20 nm, recording at a higher speed and a higher optical contrast can be reconciled. By regulating the thickness of the recording layer 53 so as to be in that range, the volume changes accompanying the phase changes can be reduced and the influences of repeated volume changes due to repetitions of overwriting on the recording layer 53 itself and on the upper and lower layers adjacent to the recording layer 53 can be lessened. Furthermore, the accumulation of irreversible microscopic deformations in the recording layer 53 is inhibited, whereby noises are diminished and durability in repetitions of overwriting is improved.

The reflecting layer 51, recording layer 53, and dielectric layers 52 and 54 are formed generally by sputtering or the like. From the standpoint of preventing oxidation and fouling at the interfaces between layers, it is desirable to conduct film deposition with an in-line apparatus in which a target for the recording layer and a target for the dielectric layers and, if necessary, a target for the reflecting layer are disposed in the same vacuum chamber. This method is superior also from the standpoint of productivity.

The protective layer 3 comprises a cured product formed by applying the radiation-curable composition of the invention by spin coating and radiation-curing the composition applied. It is disposed so as to be in contact with the recording/reproducing functional layer 5 and has a flat ring shape. The protective layer 3 is made of a material capable of transmitting the laser light to be used for recording/reproducing. The transmittance of the protective layer 3, as measured at the wavelength of the light to be used for recording/reproducing, should be generally 80% or higher, preferably 85% or higher, more preferably 89% or higher. As long as the transmittance thereof is within such a range, the loss caused by the absorption of recording/reproducing light can be minimized. On the other hand, the transmittance of the protective layer 3 is generally 99% or lower because of the performance of the material used, although it most preferably is 100%.

It is desirable that the protective layer 3 should be sufficiently transparent to the blue laser light having a wavelength around 405 nm used for recording/reproducing in optical disks and have the property of protecting the recording layer 53 formed over the substrate 1 against water and dust. In addition, the surface hardness of the protective layer 3 is preferably B or higher in terms of surface hardness as measured through the pencil hardness test in accordance with JIS K5400. Too low hardnesses are undesirable because the surface is apt to be marred. Too high hardness are undesirable because this cured product tends to be brittle and is apt to crack or peel off, although such high hardnesses themselves pose no problem.

Furthermore, the protective layer 3 preferably has higher adhesion to the recording/reproducing functional layer 5. It preferably further has higher long-term adhesion. When this optical recording medium 10 is placed in an environment of 80° C. and 85% RH for 100 hours, preferably 200 hours, then the proportion of the area where the protective layer 3 is adherent to the recording/reproducing functional layer 5 is preferably 50% or higher, more preferably 80% or higher, especially preferably 100%, based on the initial adhesion area.

The thickness of the protective layer 3 is generally 10 μm or larger, preferably 20 μm or larger, more preferably 30 μm or larger, even more preferably 70 μm or larger, especially preferably 85 μm or larger. When the thickness of the protective layer 3 is regulated so as to be within that range, influences of dust particles or mars adherent to or formed in the surface of the protective layer 3 can be lessened. Furthermore, this protective layer 3 can have a thickness sufficient to protect the recording/reproducing functional layer 5 against moisture and other substances present in the surrounding atmosphere. On the other hand, the thickness thereof is generally 300 μm or smaller, preferably 130 μm or smaller, more preferably 115 μm or smaller. The protective layer 3 having a thickness within that range can be easily formed by a general coating technique, e.g., spin coating, so as to have evenness of film thickness. It is preferred that the protective layer 3 be formed in an even thickness over an area which covers the recording/reproducing functional layer 5.

A hard coat layer may have been formed on the protective layer 3, although it is not shown in FIG. 1. This hard coat layer is preferably formed, for example, from a radiation-curable composition comprising a radiation-curable monomer and/or oligomer having a functional group selected from the group consisting of (meth)acryloyl, vinyl, and mercapto groups, a fluorine compound, a silicone compound, and the silica particles described above. It is preferred that a cured product be formed from this composition so that the cured product has a light transmittance, as measured at a wavelength of 550 nm, of 80% or higher and further has a contact angle with water of 90° or larger and a surface hardness of HB or higher.

The optical recording medium thus obtained may be used alone, or two or more such optical recording media may be used as a laminate thereof. The recording medium may be incorporated into a cartridge optionally after a hub is attached thereto.

### EXAMPLES

The invention will be explained below in detail by reference to Examples. However, the invention should not be construed as being limited to these Examples unless the invention departs from the spirit thereof. Shown below are: an example of the preparation of silica particles used in the Examples and Comparative Examples; methods of preparing urethane acrylate composition liquids; examples of the preparation of radiation-curable compositions; an example of the preparation of a curable composition for a hard coat layer; examples of the production of multilayer structures of a radiation-cured product; and methods of examining/evaluating these multilayer structures for light transmittance, tensile strength at break, surface hardness, resistance to deformation by heat/humidity, and balance between hardness and deformation resistance.

### Silica Particle Preparation Example

With 234 g of tetramethoxysilane was mixed 74 g of methanol. Thereafter, 22.2 g of 0.05% hydrochloric acid was added thereto and a hydrolysis reaction was conducted at 65° C. for 2 hours. Subsequently, the temperature in the system was elevated to 130° C. and the methanol generated was removed. While nitrogen gas was being introduced, the temperature was then gradually elevated to 150° C. and the system was held in this state for 3 hours. The tetramethoxysilane monomer remaining was removed. Thus, a tetramethoxysilane oligomer was produced. Subsequently, 624 g of methanol was added to 308 g of the tetramethoxysilane oligomer obtained. After this mixture was stirred to obtain a homogeneous solution, 3.1 g of acetylacetone aluminum as a catalyst was dissolved therein. To this solution was gradually added dropwise 65 g of desalted water with stirring. The resultant mixture was successively stirred at 60° C. for 2 hours to grow silica particles. The silica particles yielded were examined for shape with a transmission electron microscope (TEM) and, as a result, the particle diameters thereof were found to be 2-5 μm.

Subsequently, 150 g of acryloyloxypropyltrimethoxysilane as a silane coupling agent and 0.5 g of dibutyltin dioctoate were added to 500 g of the alcohol solution of silica particles obtained. The resultant mixture was stirred at 60° C. for 2 hours to bring the silane coupling agent into contact with the surface of the silica particles. Thereafter, 67.2 g of desalted water and 150 g of acryloyloxypropyltrimethoxysilane were gradually added thereto, and this mixture was stirred at 60° C. for 4 hours to conduct a hydrolysis reaction. Thus, a solution of silica particles treated with the silane coupling agent was prepared.

### <Urethane Acrylate Composition Liquid A>

Into a four-necked flask was introduced 66.7 g of isophorone diisocyanate. This flask was heated on an oil bath to 70-80° C. while gently stirring the contents until the temperature thereof became constant. After the temperature of the contents became constant, 7.4 g of dimethylolbutanoic acid (manufactured by Nippon Kasei Chemical Co., Ltd.) was added. Thereto was further added dropwise a mixture of 42.1 g of a polytetramethylene ether glycol (“PTMG 850” manufactured by Mitsubishi Chemical Corp.), 34.4 g of a polyester polyol (“Kuraray Polyol P-1090” manufactured by Kuraray Co., Ltd.), and 7.1 g of a polyester polyol (“Kuraray Polyol P-590” manufactured by Kuraray Co., Ltd.) through a dropping funnel. This mixture was stirred for 2 hours while keeping the temperature thereof at 80° C. and then cooled to 70° C. Thereafter, a mixture of 43.6 g of hydroxyethyl acrylate, 0.06 g of methoquinone, and 0.04 g of dibutyltin dioctoate was added dropwise to that mixture through a dropping funnel. After completion of the dropwise addition, the temperature of the resultant mixture was elevated to 80° C. and this mixture was stirred at this temperature for 10 hours to thereby synthesize a urethane acrylate oligomer having a polyether polyol skeleton and polyester polyol skeletons. This oligomer was discharged after 67.3 g of isobornyl acrylate was added thereto to lower the viscosity thereof. Thus, urethane acrylate composition liquid A was prepared.

### <Urethane Acrylate Composition Liquid B>

Into a four-necked flask was introduced 66.7 g of isophorone diisocyanate. This flask was heated on an oil bath to 70-80° C. while gently stirring the contents until the temperature thereof became constant. After the temperature of the contents became constant, 7.4 g of dimethylolbutanoic acid (manufactured by Nippon Kasei Chemical Co., Ltd.) was added. Thereto was further added dropwise a mixture of 41.4 g of a polytetramethylene ether glycol (“PTMG 850” manufactured by Mitsubishi Chemical Corp.), 33.7 g of a polycarbonate polyol (“Kuraray Polyol C-1090” manufactured by Kuraray Co., Ltd.), and 8.1 g of a polycarbonate polyol (“Kuraray Polyol C-590” manufactured by Kuraray Co., Ltd.) through a dropping funnel. This mixture was stirred for 2 hours while keeping the temperature thereof at 80° C. and then cooled to 70° C. Thereafter, a mixture of 43.6 g of hydroxyethyl acrylate, 0.06 g of methoquinone, and 0.04 g of dibutyltin dioctoate was added dropwise to that mixture through a dropping funnel. After completion of the dropwise addition, the temperature of the resultant mixture was elevated to 80° C. and this mixture was stirred at this temperature for 10 hours to thereby synthesize a urethane acrylate oligomer having a polyether polyol skeleton and polycarbonate polyol skeletons. This oligomer was discharged after 67.3 g of isobornyl acrylate was added thereto to lower the viscosity thereof. Thus, urethane acrylate composition liquid B was prepared.

### <Urethane Acrylate Composition Liquid C>

Into a four-necked flask was introduced 66.7 g of isophorone diisocyanate. This flask was heated on an oil bath to 70-80° C. while gently stirring the contents until the temperature thereof became constant. After the temperature of the contents became constant, 7.4 g of dimethylolbutanoic acid (manufactured by Nippon Kasei Chemical Co., Ltd.) was added. Thereto was further added dropwise a mixture of 34.4 g of a polyester polyol (“Kuraray Polyol P-1090” manufactured by Kuraray Co., Ltd.), 7.1 g of a polyester polyol (“Kuraray Polyol P-590” manufactured by Kuraray Co., Ltd.), 33.8 g of a polycarbonate polyol (“Kuraray Polyol C-1090” manufactured by Kuraray Co., Ltd.), and 7.7 g of a polycarbonate polyol (“Kuraray Polyol C-590” manufactured by Kuraray Co., Ltd.) through a dropping funnel. This mixture was stirred for 2 hours while keeping the temperature thereof at 80° C. and then cooled to 70° C. Thereafter, a mixture of 43.6 g of hydroxyethyl acrylate, 0.06 g of methoquinone, and 0.04 g of dibutyltin dioctoate was added dropwise to that mixture through a dropping funnel. After completion of the dropwise addition, the temperature of the resultant mixture was elevated to 80° C. and this mixture was stirred at this temperature for 10 hours to thereby synthesize a urethane acrylate oligomer having polyester polyol skeletons and polycarbonate polyol skeletons. This oligomer was discharged after 67.3 g of isobornyl acrylate was added thereto to lower the viscosity thereof. Thus, urethane acrylate composition liquid C was prepared.

### <Urethane Acrylate Composition Liquid D>

Into a four-necked flask were introduced 66.7 g of isophorone diisocyanate and 0.02 g of dibutyltin laurate. This flask was heated on an oil bath to 70-80° C. while gently stirring the contents until the temperature thereof became constant. After the temperature of the contents became constant, a mixture of 7.4 g of dimethylolbutanoic acid (manufactured by Nippon Kasei Chemical Co., Ltd.) and 85.0 g of a polytetramethylene ether glycol (“PTMG 850” manufactured by Mitsubishi Chemical Corp.) was added dropwise thereto through a dropping funnel. This mixture was stirred for 2 hours while keeping the temperature thereof at 70° C. Subsequently, a mixture of 43.5 g of hydroxyethyl acrylate and 0.09 g of methoquinone was added dropwise to that mixture through a dropping funnel and this mixture was stirred for 10 hours to thereby synthesize a urethane acrylate oligomer having a polyether polyol skeleton. This oligomer was discharged after 70.0 g of isobornyl acrylate was added thereto to lower the viscosity thereof. Thus, urethane acrylate composition liquid D was prepared.

### <Urethane Acrylate Composition Liquid E>

Into a four-necked flask was introduced 66.7 g of isophorone diisocyanate. This flask was heated on an oil bath to 70-80° C. while gently stirring the contents until the temperature thereof became constant. After the temperature of the contents became constant, 7.4 g of dimethylolbutanoic acid (manufactured by Nippon Kasei Chemical Co., Ltd.) was added. Thereto was further added dropwise a mixture of 68.6 g of a polyester polyol (“Kuraray Polyol P-1090” manufactured by Kuraray Co., Ltd.) and 14.4 g of a polyester polyol (“Kuraray Polyol P-590” manufactured by Kuraray Co., Ltd.) through a dropping funnel. This mixture was stirred for 2 hours while keeping the temperature thereof at 80° C. and then cooled to 70° C. Thereafter, a mixture of 43.6 g of hydroxyethyl acrylate, 0.06 g of methoquinone, and 0.04 g of dibutyltin dioctoate was added dropwise to that mixture through a dropping funnel. After completion of the dropwise addition, the temperature of the resultant mixture was elevated to 80° C. and this mixture was stirred at this temperature for 10 hours to thereby synthesize a urethane acrylate oligomer having polyester polyol skeletons. This oligomer was discharged after 67.2 g of acryloylmorpholine was added thereto to lower the viscosity thereof. Thus, urethane acrylate composition liquid E was prepared.

### <Urethane Acrylate Composition Liquid F>

Into a four-necked flask was introduced 66.7 g of isophorone diisocyanate. This flask was heated on an oil bath to 70-80° C. while gently stirring the contents until the temperature thereof became constant. After the temperature of the contents became constant, 7.4 g of dimethylolbutanoic acid (manufactured by Nippon Kasei Chemical Co., Ltd.) was added. Thereto was further added dropwise a mixture of 67.3 g of a polycarbonate polyol (“Kuraray Polyol C-1090” manufactured by Kuraray Co., Ltd.) and 15.7 g of a polycarbonate polyol (“Kuraray Polyol C-590” manufactured by Kuraray Co., Ltd.) through a dropping funnel. This mixture was stirred for 2 hours while keeping the temperature thereof at 80° C. and then cooled to 70° C. Thereafter, a mixture of 43.6 g of hydroxyethyl acrylate, 0.06 g of methoquinone, and 0.04 g of dibutyltin dioctoate was added dropwise to that mixture through a dropping funnel. After completion of the dropwise addition, the temperature of the resultant mixture was elevated to 80° C. and this mixture was stirred at this temperature for 10 hours to thereby synthesize a urethane acrylate oligomer having polycarbonate polyol skeletons. This oligomer was discharged after 67.0 g of acryloylmorpholine was added thereto to lower the viscosity thereof. Thus, urethane acrylate composition liquid F was prepared.

### <Preparation of Urethane Acrylate Composition Liquid G>

Into a four-necked flask was introduced 66.7 g of isophorone diisocyanate. This flask was heated on an oil bath to 70-80° C. while gently stirring the contents until the temperature thereof became constant. After the temperature of the contents became constant, 7.4 g of dimethylolbutanoic acid (manufactured by Nippon Kasei Chemical Co., Ltd.) was added. Thereto was further added dropwise a mixture of 42.1 g of a polytetramethylene ether glycol (“PTMG 850” manufactured by Mitsubishi Chemical Corp.), 34.4 g of a polyester polyol (“Kuraray Polyol P-1090” manufactured by Kuraray Co., Ltd.), and 7.1 g of a polyester polyol (“Kuraray Polyol P-590” manufactured by Kuraray Co., Ltd.) through a dropping funnel. This mixture was stirred for 2 hours while keeping the temperature thereof at 80° C. and then cooled to 70° C. Thereafter, a mixture of 43.6 g of hydroxyethyl acrylate, 0.06 g of methoquinone, and 0.04 g of dibutyltin dioctoate was added dropwise to that mixture through a dropping funnel. After completion of the dropwise addition, the temperature of the resultant mixture was elevated to 80° C. and this mixture was stirred at this temperature for 10 hours to thereby synthesize a urethane acrylate oligomer having a polyether polyol skeleton and polyester polyol skeletons. To this oligomer were added 26.9 g of isobornyl acrylate and 40.4 g of dicyclopentadienyldimethanol diacrylate (“DCPA” manufactured by Shin-Nakamura Chemical Co., Ltd.) to lower the viscosity thereof. Thus, urethane acrylate composition liquid G was prepared. The content of acid groups in this urethane acrylate composition liquid G was 1.9×10⁻⁴ eq/g.

### <Preparation of Urethane Acrylate Composition Liquid H>

Into a four-necked flask were introduced 1,111.5 g of isophorone diisocyanate and 0.3 g of dibutyltin laurate. This flask was heated on an oil bath to 70-80° C. while gently stirring the contents until the temperature thereof became constant. After the temperature of the contents became constant, a mixture of 148.0 g of 1,4-butanediol and 708.3 g of a polytetramethylene ether glycol was added dropwise thereto through a dropping funnel. This mixture was stirred for 2 hours while keeping the temperature thereof at 80° C. and then cooled to 70° C. Thereafter, a mixture of 725.0 g of hydroxyethyl acrylate and 1.5 g of methoquinone was added dropwise to that mixture through a dropping funnel. After completion of the dropwise addition, the temperature of the resultant mixture was elevated to 80° C. and this mixture was stirred at this temperature for 10 hours to thereby synthesize a urethane acrylate oligomer having a polyether polyol skeleton and a polyester polyol skeleton.

Subsequently, 608.3 g of the urethane acrylate oligomer obtained above was introduced into a flask. After the contents were heated to 70° C., 92.8 g of isobornyl acrylate and 139.3 g of 1,6-hexanediol were added thereto to lower the viscosity thereof. Furthermore, 44.0 g of 2-acryloyloxyethylsuccinic acid (“HOA-MS” manufactured by Kyoeisha Chemical Co., Ltd.) was added as a (meth)acrylate having an acid group. Thus, urethane acrylate composition liquid H was prepared. The content of acid groups in this urethane acrylate composition liquid H was 2.3×10⁻⁴ eq/g.

### <Preparation of Urethane Acrylate Composition Liquid I>

To the urethane acrylate oligomer having a polyether polyol skeleton and polyester polyol skeletons which had been produced in preparing urethane acrylate composition liquid G were added 26.9 g of tetrahydrofurfuryl acrylate and 40.4 g of dicyclopentadienyldimethanol diacrylate (“DCPA” manufactured by Shin-Nakamura Chemical Co., Ltd.) to lower the viscosity thereof. Thus, urethane acrylate composition liquid I was prepared. The content of acid groups in this urethane acrylate composition liquid I was 1.9×10⁻⁴ eq/g.

### <Preparation of Urethane Acrylate Composition Liquid J>

To the urethane acrylate oligomer having a polyether polyol skeleton and polyester polyol skeletons which had been produced in preparing urethane acrylate composition liquid G were added 26.9 g of dicyclopentadienyl acrylate and 40.4 g of dicyclopentadienyldimethanol diacrylate (“DCPA” manufactured by Shin-Nakamura Chemical Co., Ltd.) to lower the viscosity thereof. Thus, urethane acrylate composition liquid J was prepared. The content of acid groups in this urethane acrylate composition liquid J was 1.9×10⁻⁴ eq/g.

### <Preparation of Curable Composition for Hard Coat Layer>

With 234 g of tetramethoxysilane was mixed 74 g of methanol. Thereafter, 22.2 g of 0.05% hydrochloric acid was added thereto and a hydrolysis reaction was conducted at 65° C. for 2 hours. Subsequently, the temperature in the system was elevated to 130° C. and the methanol generated was removed. While nitrogen gas was being introduced, the temperature was then gradually elevated to 150° C. and the system was held in this state for 3 hours. The tetramethoxysilane monomer remaining was removed. Thus, a tetramethoxysilane oligomer was produced. Subsequently, 45.2 g of methanol was added to 24.6 g of the tetramethoxysilane oligomer obtained. After this mixture was stirred to obtain a homogeneous solution, 4.9 g of a 5% by weight methanol solution of acetylacetone aluminum as a catalyst was mixed therewith. To this solution was gradually added dropwise 5.2 g of desalted water with stirring. The resultant mixture was successively stirred at 60° C. for 2 hours to grow silica particles. The silica particles yielded were examined for shape with a transmission electron microscope (TEM) and, as a result, the particle diameters thereof were found to be 2-5 μm.

Subsequently, 24 g of acryloyloxypropyltrimethoxysilane as a silane coupling agent and 0.8 g of dibutyltin dioctoate were added to the alcohol solution of silica particles obtained. The resultant mixture was stirred at 60° C. for 2 hours to react the silane coupling agent with the surface of the silica particles. Thereafter, 10.8 g of desalted water and 24 g of acryloyloxypropyltrimethoxysilane were added thereto, and this mixture was stirred at 60° C. for 2 hours to conduct a hydrolysis reaction. Thus, a solution of silica particles treated with the silane coupling agent was prepared.

In 59.8 g of a toluene/butanol/propylene glycol monomethyl ether acetate=1/1/2 mixed solvent were dissolved 7.4 g of the solution of silane-coupling-agent-treated silica particles obtained above, 9.9 g of urethane acrylate composition liquid H obtained above, 1.1 g of hydroxyethyl acrylate, 1.1 g of dicyclopentadienyldimethanol diacrylate (“DCPA” manufactured by Shin-Nakamura Chemical Co., Ltd.), 9.9 g of ditrimethylolpropane hexaacrylate (“AD-TMP” manufactured by Shin-Nakamura Chemical Co., Ltd.), 0.3 g of acryloyloxypropyltrimethoxysialne and 0.05 g of 3,3,3-trifluoropropyltrimethoxysilane as silane coupling agents, 0.45 g of a silicone oil (“KF-351A” manufactured by Shin-Etsu Chemical Co., Ltd.), and 1.24 g of 1-hydroxycyclohexyl phenyl ketone and 1.24 g of benzophenone as polymerization initiators. This solution was mixed by stirring until it became homogeneous. Thus, a curable composition for a hard coat layer was prepared.

### Example 1

To 60.0 g of the solution of silane-coupling-agent-treated silica particles obtained above were added 57.7 g of urethane acrylate composition liquid A obtained above, 5.8 g of hydroxyethyl acrylate, 11.5 g of isobornyl acrylate, and 5.8 g of a polypropylene glycol diacrylate (“APG 400” manufactured by Shin-Nakamura Chemical Co., Ltd.). Thereto were added 1.7 g of 1-hydroxycyclohexyl phenyl ketone and 1.7 g of benzophenone as radical generators. The resultant mixture was stirred at room temperature for 30 minutes to obtain a transparent radiation-curable composition having an inorganic-ingredient content of 20% by weight. Furthermore, this composition was evaporated at 50° C. for 2 hours at a reduced pressure to remove the low-boiling ingredients contained in the composition. Thus, a solvent-free radiation-curable composition was prepared.

The radiation-curable composition obtained was examined for terminal vinyl group content, nitrogen atom amount, acid group content, and viscosity by the methods shown below. The results obtained are shown in Table 1.

<Terminal Vinyl Group Content>

The composition was analyzed by infrared spectroscopy to determine the area of the peak appearing at around 810 cm⁻¹ attributable to the out-of-plane deformation vibration of terminal vinyl C—H. The terminal vinyl group content was determined from the peak area by the working curve method.

<Nitrogen Atom Amount>

A sample was gasified and oxidized in a reaction furnace at a temperature of 800° C. or higher and the nitrogen monoxide generated was determined by a chemiluminescent method.

<Acid Group Content>

The content of acid groups was determined by the back titration method employing a neutralization reaction with an amine.

<Viscosity>

Measurement was made with an E-type viscometer in a constant-temperature constant-humidity room of 25° C. and 65% RH.

Subsequently, the radiation-curable composition obtained above was applied to a surface of a poly(ethylene terephthalate) film having a thickness of 100±5 μm as a substrate for the measurements of light transmittance, tensile strength at break, and surface hardness and to a surface of a polycarbonate disk having a diameter of 130 mm and a thickness of 1.2±0.2 mm as a substrate for the examination of resistance to deformation by heat/humidity. The application was conducted with a spin coater in a thickness of 100±5 μm in terms of cured-film thickness. A high-pressure mercury lamp having an output of 80 W/cm disposed apart from each coating film at a distance of 15 cm therefrom was used to irradiate the coating film with ultraviolet in a light intensity of 1 J/cm². Thus, multilayer structures having a cured product layer were produced. Furthermore, with respect to the multilayer structure for the examination of resistance to deformation by heat/humidity, the curable composition for a hard coat layer obtained above was applied to the upper side of the multilayer structure with a spin coater in a thickness of 3.0±5 μm in terms of cured-film thickness. This coated structure was dried in an oven at 80° C. for 2 minutes. Thereafter, a high-pressure mercury lamp having an output of 80 W/cm disposed apart from the coating film at a distance of 15 cm therefrom was used to irradiate the coating film with ultraviolet in a light intensity of 1 J/cm². Thus, a hard coat layer was formed. The multilayer structures obtained were allowed to stand at room temperature for 1 hour and then examined and evaluated for light transmittance, tensile strength at break, surface hardness, and resistance to deformation by heat/humidity by the methods shown below. The results obtained are shown in Table 1.

<Light Transmittance>

The cured product layer was peeled from the multilayer structure obtained above. The light transmittance of this cured product layer per optical path length of 0.1 mm was measured with ultraviolet/visible light absorptiometer Type HP8453, manufactured by Hewlett-Packard Co., at a wavelength of 550 nm.

<Tensile Strength at Break>

The cured product layer was peeled from the multilayer structure obtained. This cured product layer was examined for tensile strength at break in accordance with JIS K7127.

<Surface Hardness>

The multilayer structure composed of a poly(ethylene terephthalate) film and the cured product layer was examined through a pencil hardness test in accordance with JIS K5400.

<Resistance to Deformation by Heat/Humidity>

The multilayer structure was placed in an environment of 80° C. and 85% RH for 100 hours and then placed on a flat plate. This structure was examined for the amount of warpage (mm) in terms of the distance between the whole circumference and the flat plate. The warpage amount was measured with respect to each of four points on the circumference of the disk-shaped multilayer structure which divided the circumference into four equal arcs; the average of these found values is referred to as “a” (mm). This multilayer structure was subsequently placed in an environment of 23° C. and 65% RH for 168 hours and then examined for warpage amount in the same manner; the average of the four found values is referred to as “b” (mm). The value of |b−a| (mm) was calculated.

Furthermore, after the placement in the latter environment, the hard coat layer was visually examined for surface cracks. The number of cracks having a length of 1 mm or longer was counted.

<Balance between Hardness and Deformation Resistance>

The cases where the hardness was 2 B or higher and the average warpage amount in the examination of resistance to deformation by heat/humidity was 0.5 mm or less are indicated by A, and the other cases are indicated by B.

### Example 2

Multilayer structures were produced in the same manner as in Example 1, except that urethane acrylate composition liquid B was used in place of urethane acrylate composition liquid A. The multilayer structures were examined and evaluated for light transmittance, tensile strength at break, surface hardness, and resistance to deformation by heat/humidity by the same methods as in Example 1. The results obtained are shown in Table 1.

### Example 3

Multilayer structures were produced in the same manner as in Example 1, except that urethane acrylate composition liquid C was used in place of urethane acrylate composition liquid A. The multilayer structures were examined and evaluated for light transmittance, tensile strength at break, surface hardness, and resistance to deformation by heat/humidity by the same methods as in Example 1. The results obtained are shown in Table 1.

### Example 4

Multilayer structures were produced in the same manner as in Example 1, except that a 1:1 mixture of urethane acrylate composition liquid D and urethane acrylate composition liquid E was used in place of urethane acrylate composition liquid A. The multilayer structures were examined and evaluated for light transmittance, tensile strength at break, surface hardness, and resistance to deformation by heat/humidity by the same methods as in Example 1. The results obtained are shown in Table 1.

### Example 5

Multilayer structures were produced in the same manner as in Example 1, except that a 1:1 mixture of urethane acrylate composition liquid D and urethane acrylate composition liquid F was used in place of urethane acrylate composition liquid A. The multilayer structures were examined and evaluated for light transmittance, tensile strength at break, surface hardness, and resistance to deformation by heat/humidity by the same methods as in Example 1. The results obtained are shown in Table 1.

### Example 6

Multilayer structures were produced in the same manner as in Example 1, except that a 1:1 mixture of urethane acrylate composition liquid E and urethane acrylate composition liquid F was used in place of urethane acrylate composition liquid A. The multilayer structures were examined and evaluated for light transmittance, tensile strength at break, surface hardness, and resistance to deformation by heat/humidity by the same methods as in Example 1. The results obtained are shown in Table 1.

### Example 7

Multilayer structures were produced in the same manner as in Example 1, except that urethane acrylate composition liquid E was used in place of urethane acrylate composition liquid A. The multilayer structures were examined and evaluated for light transmittance, tensile strength at break, surface hardness, and resistance to deformation by heat/humidity by the same methods as in Example 1. The results obtained are shown in Table 1.

### Example 8

Eighty grams of urethane acrylate composition liquid G obtained above was mixed with 10 g of hydroxyethyl acrylate and 10 g of isobornyl acrylate by stirring at room temperature for 1 hour. Thereafter, 3.5 g of 1-hydroxycyclohexyl phenyl ketone and 0.5 g of benzophenone were added thereto as polymerization initiators. The resultant mixture was stirred at room temperature for 3 hours to thereby obtain a radiation-curable composition.

### Example 9

Fifty grams of urethane acrylate composition liquid G obtained above was mixed with 30 g of urethane acrylate composition liquid H obtained above, 10 g of hydroxyethyl acrylate, and 10 g of isobornyl acrylate by stirring at room temperature for 1 hour. Thereafter, 4.0 g of 1-hydroxycyclohexyl phenyl ketone was added thereto as a polymerization initiator. The resultant mixture was stirred at room temperature for 3 hours to thereby obtain a radiation-curable composition. The radiation-curable composition obtained was examined for terminal vinyl group content, nitrogen atom amount, acid group content, and viscosity by the same methods as described above, and the results thereof are shown in Table 1. Furthermore, multilayer structures were produced in the same manner as described above and examined and evaluated for light transmittance, surface hardness, and resistance to deformation by heat/humidity by the same methods as described above. The results obtained are shown in Table 1.

### Example 10

Eighty grams of urethane acrylate composition liquid I obtained above was mixed with 10 g of hydroxyethyl acrylate and 10 g of tetrahydrofurfuryl acrylate by stirring at room temperature for 1 hour. Thereafter, 3.5 g of 1-hydroxycyclohexyl phenyl ketone and 0.5 g of benzophenone were added thereto as polymerization initiators. The resultant mixture was stirred at room temperature for 3 hours to thereby obtain a radiation-curable composition. The radiation-curable composition obtained was examined for terminal vinyl group content, nitrogen atom amount, acid group content, and viscosity by the same methods as described above, and the results thereof are shown in Table 1. Furthermore, multilayer structures were produced in the same manner as described above and examined and evaluated for light transmittance, surface hardness, and resistance to deformation by heat/humidity by the same methods as described above. The results obtained are shown in Table 1.

### Example 11

Eighty grams of urethane acrylate composition liquid J obtained above was mixed with 10 g of hydroxyethyl acrylate and 10 g of dicyclopentadienyl acrylate by stirring at room temperature for 1 hour. Thereafter, 3.5 g of 1-hydroxycyclohexyl phenyl ketone and 0.5 g of benzophenone were added thereto as polymerization initiators. The resultant mixture was stirred at room temperature for 3 hours to thereby obtain a radiation-curable composition. The radiation-curable composition obtained was examined for terminal vinyl group content, nitrogen atom amount, acid group content, and viscosity by the same methods as described above, and the results thereof are shown in Table 1. Furthermore, multilayer structures were produced in the same manner as described above and examined and evaluated for light transmittance, surface hardness, and resistance to deformation by heat/humidity by the same methods as described above. The results obtained are shown in Table 1.

### Example 12

A radiation-curable composition was obtained in the same manner as in Example 1, except that 40 g of urethane acrylate composition liquid G and 40 g of dicyclopentadienyldimethanol diacrylate were used in place of 80 g of urethane acrylate composition liquid G. The radiation-curable composition obtained was examined for terminal vinyl group content, nitrogen atom amount, acid group content, and viscosity by the same methods as described above. Furthermore, multilayer structures were produced in the same manner as described above and examined and evaluated for light transmittance, surface hardness, and resistance to deformation by heat/humidity by the same methods as described above. The results obtained are shown in Table 1.

### Comparative Example 1

Multilayer structures were produced in the same manner as in Example 1, except that urethane acrylate composition liquid D was used in place of urethane acrylate composition liquid A. The multilayer structures were examined and evaluated for light transmittance, tensile strength at break, surface hardness, and resistance to deformation by heat/humidity by the same methods as in Example 1. The results obtained are shown in Table 1.

### Comparative Example 2

Multilayer structures were produced in the same manner as in Example 1, except that urethane acrylate composition liquid F was used in place of urethane acrylate composition liquid A. The multilayer structures were examined and evaluated for light transmittance, tensile strength at break, surface hardness, and resistance to deformation by heat/humidity by the same methods as in Example 1. The results obtained are shown in Table 1.

TABLE 1

| | | | | | | |
|---|---|---|---|---|---|---|
| Ex. 1 | Ex. 2 | Ex. 3 | Ex. 4 | Ex. 5 | Ex. 6 | Ex. 7 |

<Radiation-Curable Composition>

| | | | | | | | | |
|---|---|---|---|---|---|---|---|---|
| Monomer/oligomer containing | | | | | | | | |
| urethane bond | | | | | | | | |
| Proportion of polyether polyol | (wt %) | 50.4 | 49.8 | 0.0 | 50.0 | 50.0 | 0.0 | 0.0 |
| skeleton to all polyol skeletons | | | | | | | | |
| Proportion of polyester polyol | (wt %) | 49.6 | 0.0 | 50.0 | 50.0 | 0.0 | 50.0 | 100.0 |
| skeleton to all polyol skeletons | | | | | | | | |
| Content of alicyclic-skeleton | (wt %) | 25.4 | 25.5 | 25.5 | 25.6 | 25.6 | 25.4 | 25.4 |
| (meth)acrylate (reactive diluent) | | | | | | | | |
| Terminal vinyl group content | (×10⁻³ mol/g) | 2.8 | 2.8 | 2.8 | 3.0 | 3.0 | 3.1 | 3.1 |
| Nitrogen atom amount | (×10⁻³ mol/g) | 1.3 | 1.3 | 1.3 | 1.8 | 1.8 | 2.3 | 2.3 |
| Acid group content | (×10⁻⁴ eq/g) | 1.1 | 1.1 | 1.1 | 1.1 | 1.1 | 1.1 | 1.1 |
| Viscosity | (cps) | 4000 | 4700 | 4800 | 3900 | 4700 | 4800 | 4200 |

<Radiation-Cured product>

| | | | | | | | | | |
|---|---|---|---|---|---|---|---|---|---|
| Light transmittance | 550 nm | (%) | 90 | 89 | 90 | 88 | 87 | 87 | 89 |
| | 400 nm | (%) | 89 | 88 | 87 | 89 | 88 | 87 | 87 |

| | | | | | | | | |
|---|---|---|---|---|---|---|---|---|
| Surface hardness | | B | HB | H | B | HB | H | 2B |
| Tensile strength at break | (MPa) | 37 | 40 | 40 | 38 | 40 | 39 | 35 |
| Resistance to deformation by | | | | | | | | |
| heat/humidity | | | | | | | | |
| 80° C./85% RH, 100 hr (a) | (mm) | 0.48 | 0.48 | 0.50 | 0.49 | 0.47 | 0.47 | 0.44 |
| +23° C./65% RH, 168 hr (b) | (mm) | 0.57 | 0.70 | 0.70 | 0.58 | 0.68 | 0.72 | 0.65 |
| \|b − a\| | (mm) | 0.09 | 0.22 | 0.20 | 0.09 | 0.21 | 0.25 | 0.21 |
| Cracking in hard coat layer | (number of cracks) | ≧20 | ≧20 | ≧20 | ≧20 | ≧20 | ≧20 | ≧20 |
| Balance between hardness and | | A | A | A | A | A | A | A |
| deformation resistance | | | | | | | | |

| | | | | | | |
|---|---|---|---|---|---|---|
| | | | | | Comp. | Comp. |
| Ex. 8 | Ex. 9 | Ex. 10 | Ex. 11 | Ex. 12 | Ex. 1 | Ex. 2 |

<Radiation-Curable Composition>

| | | | | | | | | |
|---|---|---|---|---|---|---|---|---|
| Monomer/oligomer containing | | | | | | | | |
| urethane bond | | | | | | | | |
| Proportion of polyether polyol | (wt %) | 50.4 | 76.8 | 50.4 | 50.4 | 50.4 | 100.0 | 0.0 |
| skeleton to all polyol skeletons | | | | | | | | |
| Proportion of polyester polyol | (wt %) | 49.6 | 23.2 | 49.6 | 49.6 | 49.6 | 0.0 | 0.0 |
| skeleton to all polyol skeletons | | | | | | | | |
| Content of alicyclic-skeleton | (wt %) | 28.9 | 24.7 | 28.9 | 28.9 | 57.7 | 25.8 | 25.4 |
| (meth)acrylate (reactive diluent) | | | | | | | | |
| Terminal vinyl group content | (×10⁻³ mol/g) | 3.6 | 3.8 | 3.8 | 3.5 | 5.0 | 2.8 | 3.1 |
| Nitrogen atom amount | (×10⁻³ mol/g) | 1.8 | 1.7 | 1.7 | 1.7 | 0.9 | 1.3 | 2.3 |
| Acid group content | (×10⁻⁴ eq/g) | 1.4 | 1.6 | 1.4 | 1.4 | 0.7 | 1.1 | 1.1 |
| Viscosity | (cps) | 4000 | 2200 | 3800 | 4100 | 1800 | 2900 | 4900 |

<Radiation-Cured product>

| | | | | | | | | | |
|---|---|---|---|---|---|---|---|---|---|
| Light transmittance | 550 nm | (%) | 90 | 89 | 90 | 90 | 89 | 89 | 90 |
| | 400 nm | (%) | 89 | 88 | 88 | 88 | 88 | 89 | 86 |

| | | | | | | | | |
|---|---|---|---|---|---|---|---|---|
| Surface hardness | | HB | HB | HB | HB | HB | B | HB |
| Tensile strength at break | (MPa) | 50 | 50 | 47 | 45 | 47 | 40 | 42 |
| Resistance to deformation by | | | | | | | | |
| heat/humidity | | | | | | | | |
| 80° C./85% RH, 100 hr (a) | (mm) | 0.08 | 0.13 | 0.15 | 0.18 | 0.22 | 0.65 | 0.68 |
| +23° C./65% RH, 168 hr (b) | (mm) | 0.18 | 0.19 | 0.23 | 0.27 | 0.45 | 0.69 | 0.95 |
| \|b − a\| | (mm) | 0.10 | 0.06 | 0.08 | 0.09 | 0.23 | 0.04 | 0.27 |
| Cracking in hard coat layer | (number of cracks) | 0 | 0 | 5 | 5 | ≧20 | ≧20 | ≧20 |
| Balance between hardness and | | A | A | A | A | A | B | B |
| deformation resistance | | | | | | | | |

While the invention has been described in detail and with reference to specific embodiments thereof, it will be apparent to one skilled in the art that various changes and modifications can be made therein without departing from the spirit and scope thereof.

This application is based on a Japanese patent application filed on Nov. 8, 2004 (Application No. 2004-323949) and a Japanese patent application filed on Oct. 11, 2005 (Application No. 2005-295993), the entire contents thereof being herein incorporated by reference.

### INDUSTRIAL APPLICABILITY

According to the invention, a radiation-curable composition can be provided which is capable of giving a cured product having excellent transparency and mechanical strength and an excellent balance between surface hardness and resistance to deformation by heat/humidity. The invention can further provide the cured product and a multilayer structure which has a layer of the cured product and is suitable for use as an optical recording medium, etc.

1. A radiation-curable composition which comprises a monomer having a radiation-curable group and/or an oligomer thereof, wherein a cured product obtained by irradiating with ultraviolet in a light intensity of 1 J/cm², has the following properties (1) to (3):
(1) when the cured product has a thickness of 100±5 μm, the cured product has a light transmittance at a wavelength of 550 nm of 80% or higher;
(2) a multilayer structure where a layer of the cured product having a thickness of 100±5 μm is formed on a poly(ethylene terephthalate) film having a thickness of 100±5 μm, has a surface hardness of HB or higher; and
(3) when a multilayer structure where the cured product having a thickness of 100±5 μm is formed on a disk made of a polycarbonate having a diameter of 130 mm and a thickness of 1.2±0.2 mm, is placed in an environment of 80° C. and 85% RH for 100 hours, then an absolute value |a| of an amount of warpage, a (mm), on the circumference of the multilayer structure is 0.5 mm or less.

2. A radiation-curable composition which comprises a monomer having a radiation-curable group and/or an oligomer thereof, wherein the radiation-curable composition has a viscosity at 25° C. of 1,000-5,000 cP, and a cured product obtained by irradiating with ultraviolet in a light intensity of 1 J/cm², has the following properties (1) to (3):
(1) when the cured product has a thickness of 100±5 μm, the cured product has a light transmittance at a wavelength of 550 nm, of 80% or higher;
(2) a multilayer structure where the cured product having a thickness of 100±5 μm is formed on a poly(ethylene terephthalate) film having a thickness of 100±5 μm, has a surface hardness of HB or higher; and
(3) when a multilayer structure where the cured product having a thickness of 100±5 μm is formed on a disk made of a polycarbonate having a diameter of 130 mm and a thickness of 1.2±0.2 mm, is placed in an environment of 80° C. and 85% RH for 100 hours and subsequently placed in an environment of 23° C. and 65% RH for 168 hours, then an absolute value |b| of the amount of warpage, b (mm), is 0.5 mm or less.

3. The radiation-curable composition of claim 1 or 2, wherein the monomer having a radiation-curable group and/or the oligomer thereof is one having a urethane bond.

4. The radiation-curable composition of claim 3, wherein the monomer and/or the oligomer thereof each having a urethane bond is one obtained by reacting at least a compound having two or more isocyanate groups in the molecule, a high-molecular polyol, and a (meth)acrylate having a hydroxyl group, in which the high-molecular polyol is one which contains two or more kinds of skeletons selected from the group consisting of a polyether polyol skeleton, a polyester polyol skeleton, and a polycarbonate polyol skeleton.

5. The radiation-curable composition of claim 4, wherein the monomer and/or the oligomer thereof each having a urethane bond is one obtained by further reacting a low-molecular polyol in which all the hydroxyl groups are connected by a hydrocarbon group.

6. A radiation-curable composition which comprises a monomer having a urethane bond and/or an oligomer thereof each obtained by reacting at least a compound having two or more isocyanate groups in the molecule, a high-molecular polyol, a (meth)acrylate having a hydroxyl group, and a low-molecular polyol in which all the hydroxyl groups are connected by a hydrocarbon group, wherein a cured product obtained by irradiating with ultraviolet in a light intensity of 1 J/cm², has the following properties (1) to (3):
(1) when the cured product has a thickness of 100±5 μm, the cured product has a light transmittance at a wavelength of 550 nm, of 80% or higher;
(2) a multilayer structure where a layer of the cured product having a thickness of 100±5 μm is formed on a poly(ethylene terephthalate) film having a thickness of 100±5 μm, has a surface hardness of 2 B or higher; and
(3) when a multilayer structure where the cured product having a thickness of 100±5 μm is formed on a disk made of a polycarbonate having a diameter of 130 mm and a thickness of 1.2±0.2 mm, is placed in an environment of 80° C. and 85% RH for 100 hours, then an absolute value |a| of an amount of warpage, a (mm), on the circumference, is 0.5 mm or less.

7. A radiation-curable composition which comprises a monomer having a urethane bond and/or an oligomer thereof each obtained by reacting at least a compound having two or more isocyanate groups in the molecule, a high-molecular polyol, a (meth)acrylate having a hydroxyl group, and a low-molecular polyol in which all the hydroxyl groups are connected by a hydrocarbon group, wherein the radiation-curable composition has a viscosity at 25° C. of 1,000-5,000 centipoise (cP), and a cured product obtained by irradiating with ultraviolet in a light intensity of 1 J/cm², has the following properties (1) to (3):
(1) when the cured product has a thickness of 100±5 μm, the cured product has a light transmittance at a wavelength of 550 nm, of 80% or higher;
(2) a multilayer structure where the cured product having a thickness of 100±5 μm is formed on a poly(ethylene terephthalate) film having a thickness of 100±5 μm, has a surface hardness of 2 B or higher; and
(3) when a multilayer structure where the cured product having a thickness of 100±5 μm is formed on a disk made of a polycarbonate having a diameter of 130 mm and a thickness of 1.2±0.2 mm, is placed in an environment of 80° C. and 85% RH for 100 hours and subsequently placed in an environment of 23° C. and 65% RH for 168 hours, then an absolute value |b| of an amount of warpage, b (mm), is 0.5 mm or less.

8. The radiation-curable composition of any one of claims 1 to 7, which further comprises a compound having an ethylenically unsaturated group.

9. A radiation-curable composition which comprises: a monomer having a urethane bond and/or an oligomer thereof each obtained by reacting at least a compound having two or more isocyanate groups in the molecule, a high-molecular polyol and a (meth)acrylate having a hydroxyl group; a compound having an ethylenically unsaturated group; a (meth)acrylate having an alicyclic skeleton; and a photopolymerization initiator having a hydroxyl group, wherein the high-molecular polyol contains a polyether polyol skeleton in an amount of 20-90% by weight and a polyester polyol skeleton in an amount of 10-80% by weight, in all polyol skeletons, and the radiation-curable composition contains a terminal vinyl group of from 2.0×10⁻³ to 4.3×10⁻³ mol/g and a nitrogen atom in an amount of from 1.3×10⁻³ to 2.5×10⁻³ mol/g.

10. The radiation-curable composition of claim 9, wherein the monomer having a urethane bond and/or the oligomer thereof is one obtained by further reacting a low-molecular polyol in which all the hydroxyl groups are connected by a hydrocarbon group.

11. The radiation-curable composition of claim 9 or 10, wherein the content of acid group is from 0.1×10⁻⁴ to 13×10⁻⁴ eq/g.

12. The radiation-curable composition of any one of claims 1 to 11, which comprises silica particles.

13. The radiation-curable composition of claim 12, wherein the silica particles are ones which have undergone a surface treatment with a surface-treating agent, and the proportion of the surface-treating agent to the silica particles is 200% by weight or higher.

14. A cured product obtained by curing the radiation-curable composition of any one of claims 1 to 13 by irradiation with a radiation.

15. The cured product of claim 14, which is for use as an optical material.

16. A multilayer structure which has a layer of the cured product of claim 14 or 15.

17. The multilayer structure of claim 16, which further comprises a hard coat layer on the cured product layer, the hard coat layer having a surface hardness of HB or higher.

18. An optical recording medium which comprises the multilayer structure of claim 16 or 17.
